(19) United States
(12) Patent Application Publication
(10) Pub. No.: US 2025/0291633 A1
(43) Pub. Date: Sep. 18, 2025

(54) HARDWARE RESOURCE SERVICE I/O

(71) Applicant: Intel Corporation, Santa Clara, CA (US)

(72) Inventors: Akhilesh Thyagaturu, Ruskin, FL (US); Gurpreet Singh Kalsi, Portland, OR (US); Jason Howard, Portland, OR (US)

(73) Assignee: Intel Corporation, Santa Clara, CA (US)

(21) Appl. No.: 19/224,544

(22) Filed: May 30, 2025

(51) Int. Cl. G06F 9/50; G06F 9/54; G06Q 30/04

(52) U.S. Cl. CPC G06F 9/5016; G06F 9/544; G06Q 30/04

(57) ABSTRACT

A device includes memory-based cross-domain solutions (M-CDS) circuitry including shared memory and logic to determine that a hardware resource of a first device is to be accessed and used by a program executed on a second device. The logic is to create a buffer in the shared memory region to implement a restricted memory-based communication channel to facilitate data exchange between the first device and the second device in association with use of the hardware resource by the program, and monitor the buffer to measure an amount of usage of the hardware resource by the program.

### GOVERNMENT RIGHTS

This invention was made with Government support under Agreement No. N66001-20-9-4016, awarded by Naval Information Warfare Center Pacific and funded by the Defense Advanced Research Project Agency. The Government has certain rights in the invention.

### BACKGROUND

A data center may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

### BRIEF DESCRIPTION OF THE FIGURES

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a simplified block diagram illustrating example components of a data center.

FIG. 2 is a simplified block diagram illustrating an example computing system.

FIG. 3 is an example approach for networking and services in an edge computing system.

FIG. 4 is a simplified block diagram illustrating an example computing device.

FIG. 5 is a simplified block diagram illustrating an example computing system.

FIG. 6 is a simplified block diagram illustrating an example cross-domain solution (CDS).

FIG. 7 is a simplified block diagram illustrating an example memory-based CDS (M-CDS) implementation.

FIG. 8 is a simplified block diagram illustrating example deployment of M-CDS devices to couple different computing domains.

FIG. 9 is a simplified block diagram illustrating an example M-CDS device.

FIG. 10 is a simplified block diagram illustrating example M-CDS management logic.

FIG. 11 is a simplified block diagram illustrating example components of an example M-CDS device.

FIG. 12 is a simplified block diagram illustrating the coupling of clients in two computing domains through an example M-CDS device.

FIG. 13 is a simplified flow diagram illustrating the example creation and use of memory-based communication channels using an example M-CDS device.

FIG. 14 is a simplified block diagram illustrating an example data transfer using an example M-CDS device.

FIG. 15 is a simplified block diagram of an example computing system.

FIG. 16 is a simplified block diagram illustrating example isolation of computing domains.

FIG. 17 is a simplified block diagram of isolated computing domains in an example computing system.

FIG. 18 is a simplified block diagram illustrating example isolation of computing domains using M-CDS devices.

FIG. 19 is a simplified block diagram illustrating an example application architecture.

FIG. 20 is a simplified block diagram illustrating an example computing platform.

FIG. 21 is a simplified block diagram illustrating example hardware of an example computing platform.

FIG. 22 is a simplified block diagram illustrating example software framework to implement a hardware access service.

FIG. 23 is a simplified block diagram illustrating example software components in an example implementation of a hardware access service.

FIG. 24 is a simplified flow diagram illustrating an example implementation of a hardware access service.

FIG. 25 illustrates a block diagram of an example processor device in accordance with certain embodiments.

Like reference numbers and designations in the various drawings indicate like elements.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

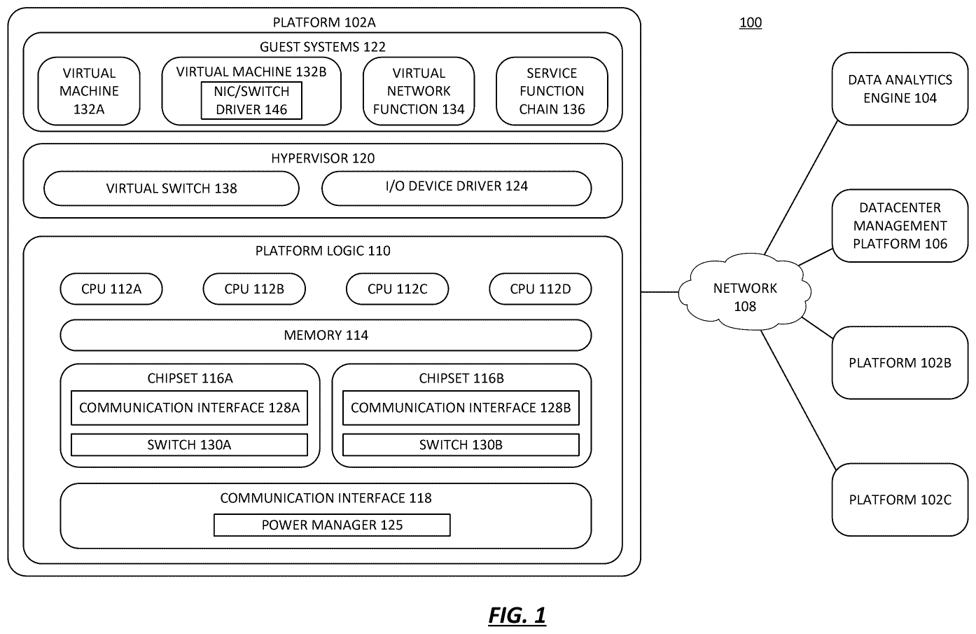

FIG. 1 illustrates a block diagram of components of a datacenter 100 in accordance with certain embodiments. In the embodiment depicted, datacenter 100 includes a plurality of platforms (e.g., 102B-102C), data analytics engine 104, and datacenter management platform 106 coupled together through network 108. In some implementations, the connection between a platform (e.g., 102) and other platforms, engines, and devices may be facilitated through a memory-based communication channel, such as implemented through a memory-based cross-domain solution (M-CDS) device, such as discussed herein. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, NVLink, Ultra Path Interconnect (UPI), Universal Chiplet Interconnect Express (UCIe), and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

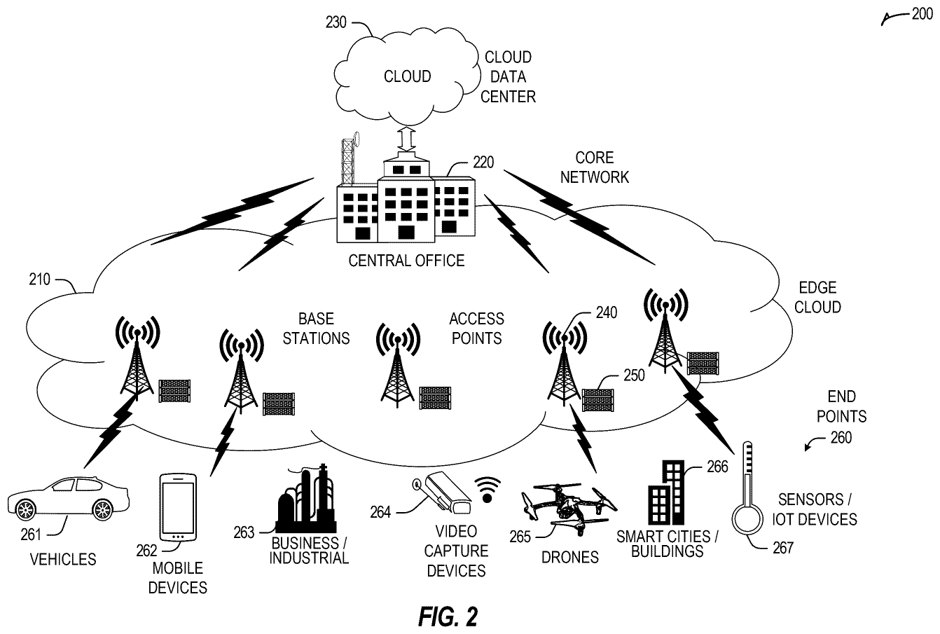

A data center, such as introduced above, may be utilized in connection with a cloud, edge, machine-to-machine, or IoT system. Indeed, principles of the solutions discussed herein may be employed in datacenter systems (e.g., server platforms) and/or devices utilized to implement a cloud, edge, or IoT environment, among other example computing environments. For instance, FIG. 2 is a block diagram 200 showing an overview of a configuration for edge computing, which includes a layer of processing referred to in many of the following examples as an “edge cloud” or “edge system”. As shown, the edge cloud 210 is co-located at an edge location, such as an access point or base station 240, a local processing hub 250, or a central office 220, and thus may include multiple entities, devices, and equipment instances. The edge cloud 210 is located much closer to the endpoint (consumer and producer) data sources 260 (e.g., autonomous vehicles 261, user equipment 262, business and industrial equipment 263, video capture devices 264, drones 265, smart cities and building devices 266, sensors and IoT devices 267, etc.) than the cloud data center 230. Compute, memory, and storage resources which are offered at the edges in the edge cloud 210 may be leveraged to provide ultra-low latency response times for services and functions used by the endpoint data sources 260 as well as reduce network backhaul traffic from the edge cloud 210 toward cloud data center 230 thus improving energy consumption and overall network usages among other benefits.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 210.

As such, an edge cloud 210 may be formed from network components and functional features operated by and within edge gateway nodes, edge aggregation nodes, or other edge compute nodes among network layers. An edge cloud 210 may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 210 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks. Further, connections between nodes and services may be implemented, in some cases, using M-CDS devices, such as discussed herein.

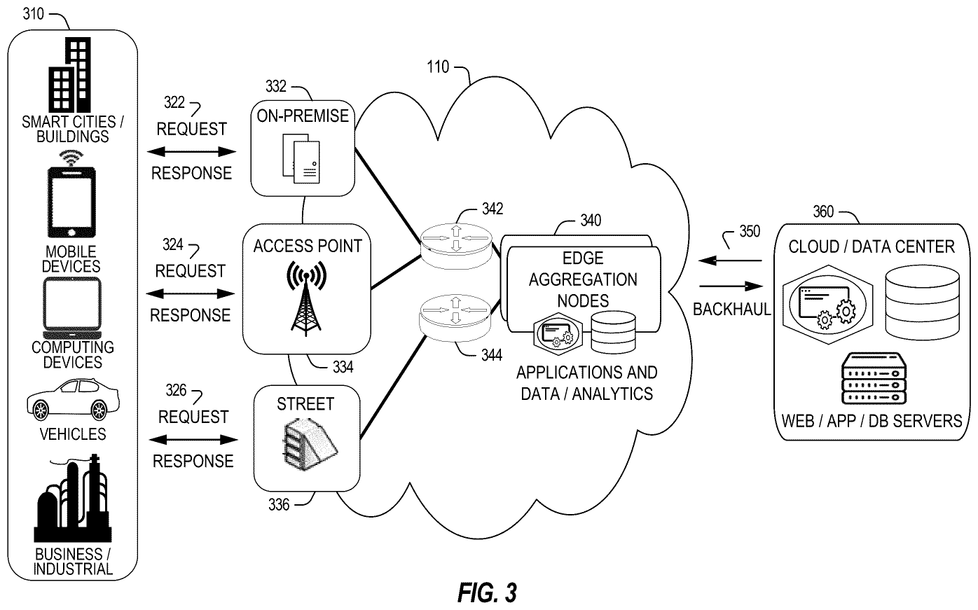

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 210 to aggregate traffic and requests. Thus, within the edge cloud 210, the TSP may deploy various compute and storage resources, such as at edge aggregation nodes 340, to provide requested content. The edge aggregation nodes 340 and other systems of the edge cloud 210 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 210 or other areas of the TSP infrastructure.

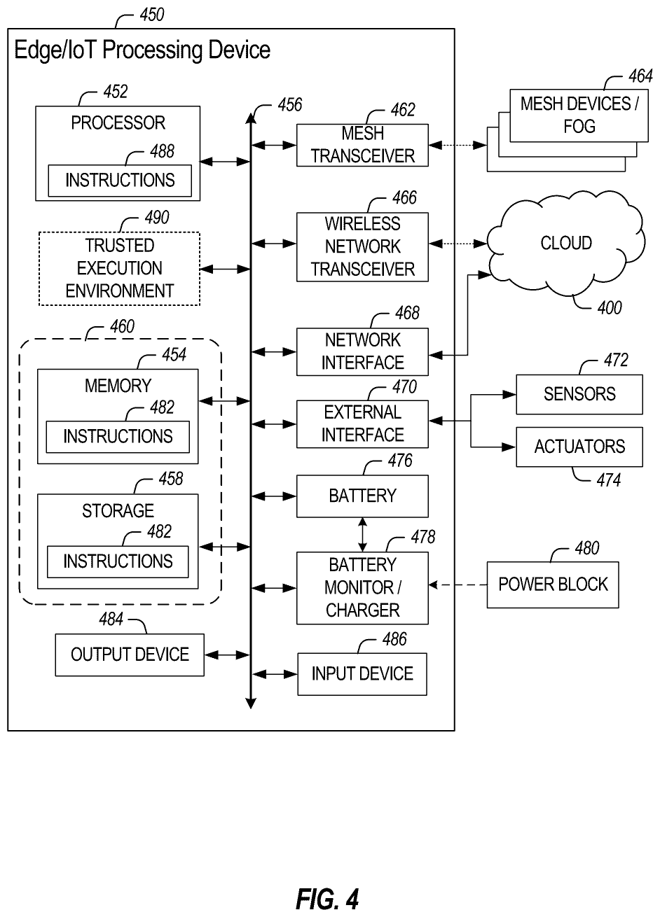

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Additionally, the block diagram of FIG. 4 is intended to depict a high-level view of components of the edge device 450. However, some of the components shown may be omitted, additional components may be present, and different arrangements of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, XD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including PCI express (PCIe), Compute Express Link (CXL), NVLink, HyperTransport, or any number of other technologies. The interconnect 456 may be a proprietary bus, for example, used in a SoC based system. Other bus systems may be included, such as an 12C interface, an SPI interface, point to point interfaces, and a power bus, among others. In some implementations, the communication may be facilitated through an M-CDS device, such as discussed herein. Indeed, in some implementations, communications according to a conventional interconnect protocol (e.g., PCIe, CXL, Ethernet, etc.) may be emulated via messages exchanged over the M-CDS, among other example implementations.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges. Further, such communications may be additionally emulated or involve message transfers using an M-CDS device, such as discussed herein, among other examples.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies. In some instances, one or more host devices may be communicatively coupled to an M-CDS device via one or more such wireless network communication channels.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensors, pressure sensors, barometric pressure sensors, and the like. The external interface 470 further may be used to connect the edge device 450 to actuators 474, such as power switches, valve actuators, an audible sound generator, a visual warning device, and the like. External devices may include M-CDS devices and other external devices may be coupled to through an M-CDS, among other example implementations.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

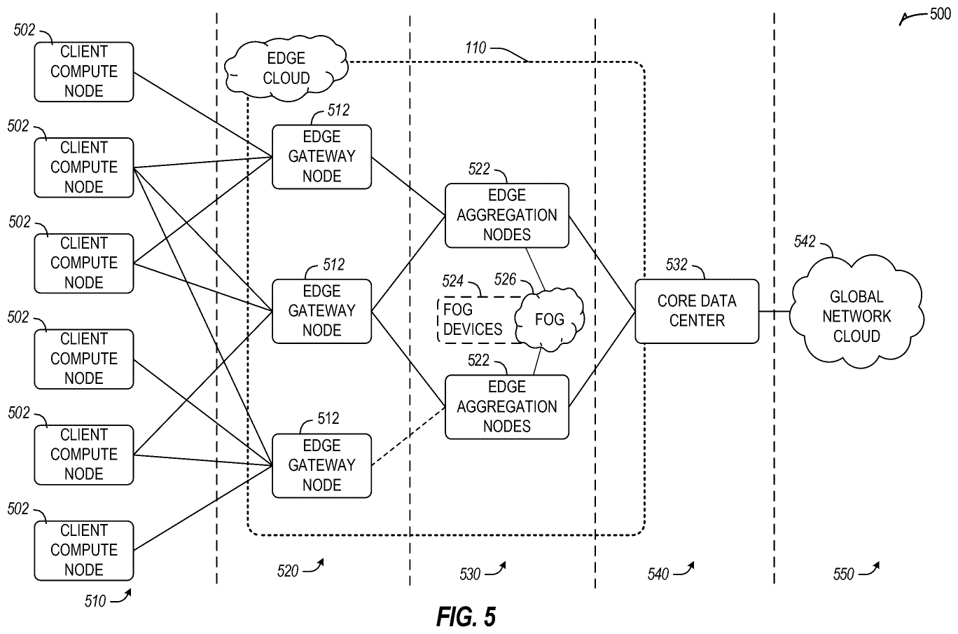

FIG. 5 provides a further abstracted overview of layers of distributed compute, including a data center or cloud and edge computing devices. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 532 may be located within, at, or near the edge cloud 210.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

In some examples, the edge cloud 210 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 210 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

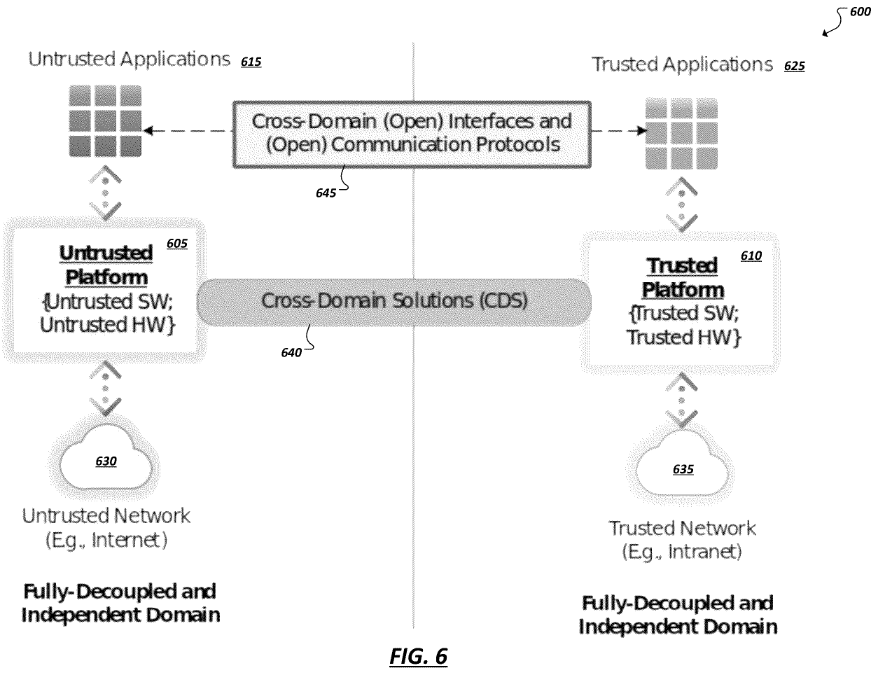

As noted above, M-CDS devices may be deployed within systems to provide secure and custom interfaces between devices (e.g., in different layers) in different domains (e.g., of distinct proprietary networks, different owners, different security or trust levels, etc.) to facilitate the secure exchange of information between the two or more domains. A CDS may function as a secure bridge between different, otherwise independent sources of information, allowing controlled data flow while keeping each domain separate and protected. FIG. 6 is a simplified block diagram 600 illustrating an overview of an example CDS implementation. For instance, two different platforms 605, 610 may be provided, which include respective processing hardware to execute respective operating systems, applications, and other software. One of the platforms (e.g., 605) may be considered an untrusted domain and executed untrusted applications 615 (e.g., based on the lack of security or trust features in its hardware or software, the identity or characteristics of the owner or provider of the platform 605, its coupling to an untrusted or insecure network (e.g., 630), etc.) and another one of the platforms (e.g., 610) may be considered or designated a trusted platform executing trusted applications 625 (e.g., based on the identity of the owner, trust execution features in the hardware and/or software of the domain) and coupled to a trusted network 635). A CDS 640 may be implemented between the platforms 605, 610 to implement a cross-domain interface 645 to enable communication and coordination between the platforms without undermining the independence and distinctive trust levels of the respective domains.

In some implementations, a CDS device provides a controlled interface: It acts as a secure gateway between domains, enforcing specific rules and policies for data access and transfer. This ensures that only authorized information flows in the right direction and at the right level of classification (e.g., to maintain the higher requirements and more demanding policies of the higher security domain). The CDS may enable information exchange by allowing for both manual and automatic data transfer, depending on the specific needs of the domains. This could involve transferring files, streaming data, or even running joint applications across different security levels. The CDS may thus be used to minimize security risks. For instance, by isolating domains and controlling data flow, CDS helps mitigate the risk of unauthorized access, data breaches, and malware infections. This may be especially crucial for protecting sensitive information in government, military, and critical infrastructure settings. The CDS may also be used to assist in enforcing security policies in that the CDS operates based on pre-defined security policies that dictate how data can be accessed, transferred, and sanitized. These policies ensure compliance with regulations and organizational security best practices (e.g., and requirements of the higher-trust domain coupled to the CDS).

CDS devices may be utilized to implement solutions, such as a data diode (e.g., to control the passing of data between applications in different domains (e.g., a microservice in an untrusted domain to a microservice in a trusted domain, etc.). The CDS device may enforce one-way data transfer, for instance, allowing data to only flow from one domain (e.g., a high-security domain) to the other (e.g., a lower-security domain). A CDS device may also be utilized to perform network traffic filtering, for instance, to implement customized firewalls and intrusion detection systems to filter network traffic and block unauthorized access attempts. A CDS device may also perform data sanitization, such as through data masking and redaction, for instance, to remove sensitive information from data (e.g., before it is transferred to a lower-security domain). A CDS device may further implement a security enclaves to provide an isolated virtual environment that can be used to run applications or store sensitive data within a lower-security domain while maintaining a high level of protection, among other examples.

CDS implementations may be used to safeguard sensitive data across various critical sectors, from the high-speed world of automotive engineering to the delicate balance of healthcare information. For instance, CDS may empower secure data exchange in a variety of domains. For example, CDS may benefit automotive applications, such as connected cars, which may assume vehicles exchanging real-time traffic data, safety alerts, and even software updates across different manufacturers and infrastructure providers. CDS may be used in such environments to ensure secure communication between these disparate systems, preventing unauthorized access and protecting critical driving data. Further, in autonomous driving applications, as self-driving cars become reality, CDS may be invaluable for securing communication between sensors, onboard computers, and external infrastructure like traffic lights and V2X (vehicle-to-everything) networks. This ensures reliable data exchange for safe and efficient autonomous driving.

CDS devices may be deployed to enhance computing systems in other example industries and applications. For instance, CDS may be employed within financial applications, such as secure data sharing. For instance, CDS may be used to facilitate secure data exchange between banks, credit bureaus, and other financial institutions, enabling faster loan approvals, better risk assessments, and improved customer service. As another example, CDS may be beneficial within healthcare applications. For instance, CDS may be advantageously applied in maintaining patient data privacy. CDS may be used to help to decouple the data in the healthcare providers and securely share patent data between hospitals, clinics, and pharmacies while complying with strict privacy regulations like HIPAA. This ensures efficient patent care while protecting sensitive medical information. CDS may also be employed within telemedicine and remote monitoring by enabling secure communication between doctors and patients during telemedicine consultations and allows for real-time data transfer from medical devices worn by patients remotely. This improves access to healthcare and allows for proactive intervention in critical situations.

Defense and national security applications may also benefit from platforms including CDS devices. For instance, in intelligence sharing, CDS facilitates secure collaboration and information sharing between different intelligence agencies and military branches. This enables quicker response times to threat and improves overall national security. Further, in systems protecting critical infrastructure, CDS safeguards data from critical infrastructure like power grids, communication networks, and transportation systems against cyber-attacks and unauthorized access. This ensures the smooth operation of these vital systems and protects national security, among other example applications and benefits.

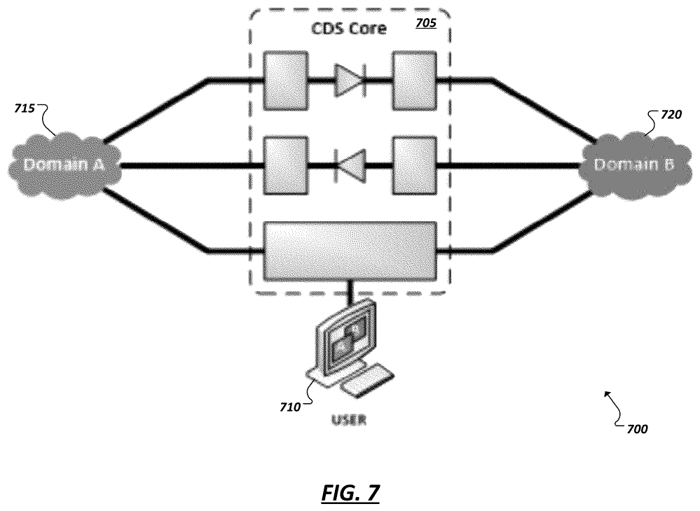

A M-CDS provides a memory-based interface that can be used to transfer the data across multiple hosts in multiple separate domains. The M-CDS device includes a memory to implement a shared memory accessible to two or more other devices coupled to the M-CDS by respective interconnects. The shared memory may implement one or more buffers for the exchange of data between the devices according to customizable policies and/or protocols defined for the shared memory. This common memory space is used to create user-defined buffers to communicate in an inter-process communication manner, but across multiple hosts. Further, logic may be provided in the M-CDS device to perform data masking and filtering of data stored in the buffer (e.g., based on customer-defined policies) so that more fine-grained data control can be performed. As an example, turning to FIG. 7, a simplified block diagram 700 is shown illustrating an example application of a M-CDS device 705. In this example, a user application (e.g., a software-as-a-service (Saas), cloud-based application, etc.) may be implemented (e.g., accessible over a network by one or multiple client devices (e.g., 710)), where the M-CDS device 705 is programmed to implement two shared buffers to enable one-way data exchange between two disparate and independent systems or domains 715, 720. The implementation of the example user application may leverage functionality and/or data provided by and through the cooperation of both of these systems 715, 720. However, due to the independence of the domains 715, 720 (and potentially security, privacy, intellectual property, or other considerations) a direct coupling of the systems 715, 720 may not be possible. In this example, the M-CDS 705 enables custom-defined communication channels through the shared memory buffers, the buffers (in this example) enabled to implement respective unidirectional data channels, or a data diode. In other examples, the same M-CDS device 705 may implement different, customer-defined communication channels through its shared memory and corresponding buffers, including bidirectional communication channels (e.g., using two buffers for each direction). Among the example advantages, an M-CDS device may enable buffers according to flexibly-defined user-defined protocols, custom-defined data formats, non-IP based host-to-host communication, and other communication similar to inter-process communication, but across multiple hosts running over non-IP-networks, among other examples.

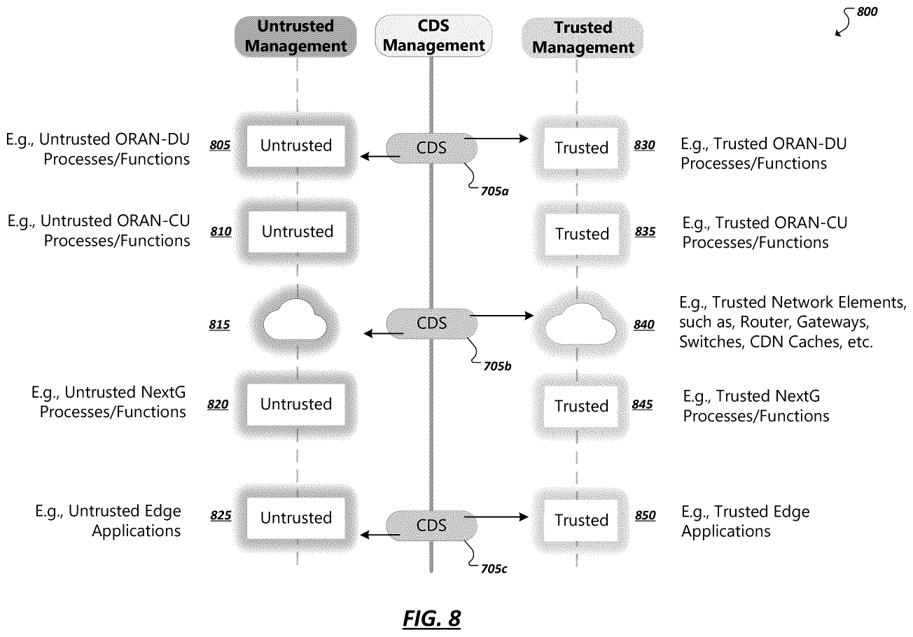

A variety of devices representing independent computing domains may couple to and communicate through an example M-CDS device. FIG. 8 is a simplified block diagram 800 illustrating various solutions utilizing one or more M-CDS devices. For instance, domain devices may include I/O devices (e.g., an FPGA, GPU, storage device, hardware accelerator, which host devices may traditionally access directly via interconnect busses (e.g., PCIe links)), a networking device providing access to an Internet Protocol (IP) IP network (e.g., a virtual or physical network interface card (NIC) that can use a network socket), a memory module that can share the memory space between independent domains that connect to a CDS device (e.g., 705a-c), etc. Some of the domain entities may be regarded as “untrusted” (e.g., based on particular security, privacy, or trust policies and the domain entities failing in one or more regards to meet such policies), while other domain entities couple are regards as “trusted” (e.g., for satisfying the security, privacy, or trust policies), with entities in untrusted domains (e.g., 805, 810, 815, 820, 825, etc.) coupling securely through a M-CDS device 705a-c to the trusted domain entities (e.g., 830, 835, 840, 845, 850, etc.). The shared memory of the M-CDS devices lends enhanced security and control, given its independence from the computing environment domains to which they are coupled to, thereby providing security and isolation as a service to the data being exchanged over the memory-implement interface provided through the M-CDS device.

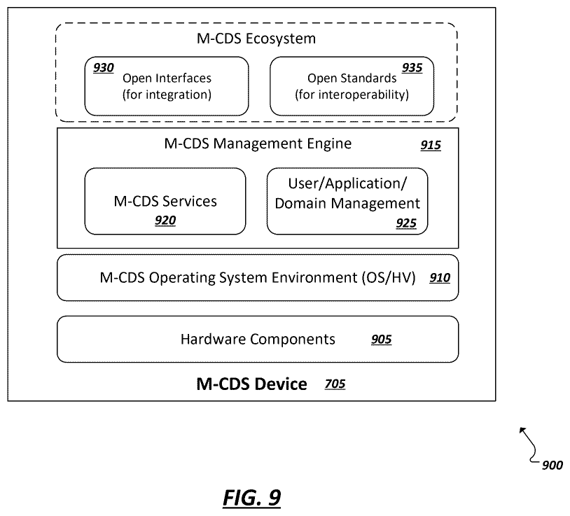

Turning to FIG. 9, a simplified block diagram 900 is shown illustrating an example implementation of an M-CDS device 705. The M-CDS device 705, in this example, may include a variety of hardware components 905 including memory and memory management circuitry, as well as one or more processing elements, including a central processing unit (CPU), hardware accelerators, programmable processor devices, among other examples. In this example, an operating system 910 may run on the M-CDS hardware 905 and support a variety of CDS services and logic implemented on the M-CDS device 705. For instance, a management engine 915 may be implemented to manage memory-based communication channels implemented through the M-CDS device 705. For instance, the management engine 915 may include M-CDS services management 920, including management of the M-CDS device control plane (e.g., to configure the communication channel), M-CDS device data plane (e.g., implementing the communication channel and its constituent policies and protocols), M-CDS device memory management, and the M-CDS databases including records which define the policies, rules, protocols, and configuration of specific M-CDS-implemented communication channels. The management engine 915 may further include management 925 of domains, users, applications, and processes (or communication endpoints), which may couple to the M-CDS device 705 and employ M-CDS device-implemented communication channels, including identifying rules and policies applying to respective endpoints, permission management and authentication of respective endpoints, telemetry reporting, and quality of service (QOS) enforcement, among other examples. One or more multiple communication channels may be established using the logic of the management engine to implement a CDS system that supports channels with multiple different open interfaces 930 and protocol standards 935, which may be custom-configured by the endpoints that are to use the channel.

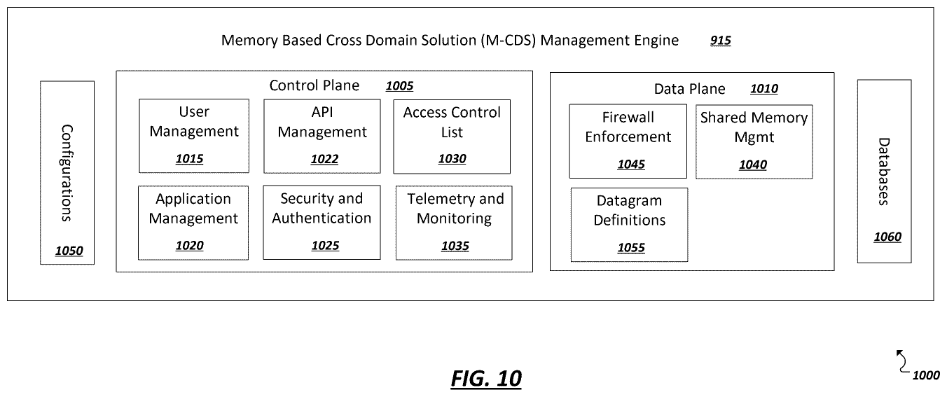

Turning to FIG. 10, a simplified block diagram 1000 illustrating example logical modules of an example M-CDS device, implemented in hardware circuitry, firmware, and/or software executed on the M-CDS device. The management engine 915 may include a control plane manager 1005 and a data plane manager 1010. The control plane manager 1005 may be responsible for managing the configuration and establishment of memory-based communication channels in the M-CDS device. With a channel configured, the data plane management 1010 may manage operation of the channel following configuration, enforcing policies and providing services to be used in the respective CDS channels based on the configurations.

An example M-CDS device may include two or more I/O ports to couple to devices representing different domains. The control plane manager 1005 may interface with the attached devices to present the M-CDS device as a memory device (e.g., RAM device) accessible by the attached devices via their respective interconnect (e.g., a respective PCIe, CXL, Ethernet, or other link). A user manager 1015 may identify a particular device, operating system, hypervisor, etc. of a domain and determine attributes of the corresponding domain, including policies and configurations to be applied for the domain. The user manager 1015 may further identify the various applications (e.g., applications, services, processes, virtual machines, or threads) that are to run on the domain's operating system or hypervisor and that may utilize communication channels implemented by the M-CDS device. An application manager 1020 may identify, for the applications of each domain, attributes, permissions, policies, and preferences for the applications so as to configure the manner in which individual applications will access and use communication channels (and their corresponding buffers) implemented in the M-CDS device. For instance, a single buffer or communication channel configured in the M-CDS to enable communication between two or more domain devices may be called upon, in some implementations, to be used by multiple, distinct applications of a domain, and the application manager 1020 may configure the channel to establish rules and policies that will govern how the applications share the channel, among other example configurations and considerations.

Continuing with the example of FIG. 10, an API manager 1022 may be provided in some implementations to assist in configuring the M-CDS device and respective channels configured in the M-CDS device to interoperate in a system where the M-CDS device couples through an external switch or another M-CDS device to one or more domains, with the communication channel being configured to consider the routing, protocols, and other attributes of the potential one-to-many coupling of the M-CDS device to potentially multiple distinct domains through a single I/O interface of the M-CDS device 705, among other examples. A security and authentication manager 1025 may define and enforce security and authentication protocols (e.g., at the domain or application level) for the channels, such that specific security features and/or policies are configured for the channel. Further, an access control manager 1030 may govern configuration access to the M-CDS device, for instance, enforcing access controls and permissions of the configuration port of the M-CDS device. QoS and telemetry monitoring may also be managed for channels of specific domains and/or applications, for instance, in accordance with QoS guarantees for various domains or applications, and telemetry monitoring access may be controlled using a QoS and telemetry monitoring manager 1035, among other example modules and logical blocks.

The management engine 915 of an example M-CDS device may additionally include data plane management logic 1010 to govern the operation of various communication channels (and corresponding buffers) configured in the memory of the M-CDS device in accordance with the configurations (e.g., 1050) implemented using the control plane manager. Individual buffers and channels may have respective functionality, rules, protocols, and policies defined for the channel, and these channel or buffer definitions may be recorded within a channel database 1060. The data plane manager 1010 may include, for instance, shared memory management engine 1040 to identify a portion of the M-CDS device memory to allocate for a specific communication channel and define pointers to provide to the domain devices that are to communicate over the communication channel to enable the devices' access to the communication channel. The shared memory management engine 1040 may leverage these pointers to effectively “turn off” a device's or application's access and use of the communication channel by retiring the pointer, disabling the device's ability to write data on the buffer (to send data on the communication channel) or read data from a buffer (to receive/retrieve data on the communication channel), among other example functions. Other security and data filtering functions may be available for use in a communication channel, based on the configuration and/or policies applied to the channel, such as firewalling by a firewall manager 1045 (e.g., to enforce policies that limit certain data from being written to or read from the communication channel buffer) or data filtering (e.g., at the field level) performed by a datagram definition manager 1055 that is aware of the data format of data written to or read from the communication channel (e.g., based on a protocol or other datagram format (including proprietary data formats) defined for the channel), to identify the presence of certain sensitive data to filter or redact such data and effectively protect such information from passing over the communication channel (e.g., from a more secure or higher trust domain to a less secure or lower trust domain), among other examples.

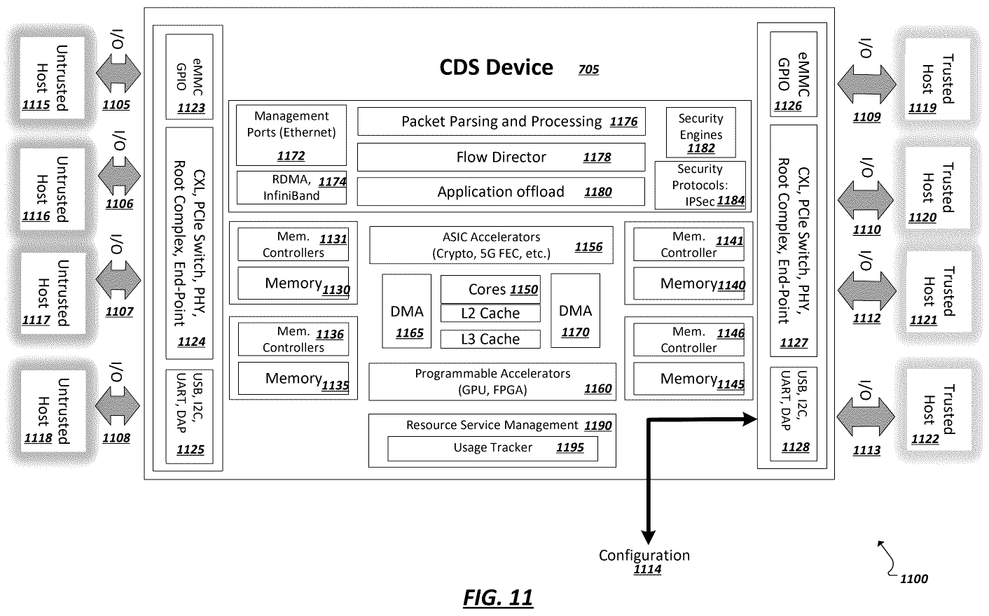

Turning to FIG. 11, a simplified block diagram 1100 is shown illustrating example hardware components of an example M-CDS device 705. An M-CDS device 705 includes two or more ports (e.g., 1105-1113) to couple to various host devices (e.g., 1115-1123) associated with two or more different domains (e.g., domains of different ownership, trust levels, security features or permissions, etc.). Different interconnect protocols may be supported by the various ports 1105-1113 of the M-CDS device 705 (such as PCIe, CXL, Ethernet, UPI, UCIe, NVLink, etc.) and corresponding protocol logic (e.g., 1124-1129) may be provided on the M-CDS device 705 to enable the M-CDS device to connect to, train, and communicate with the host devices (e.g., 1115-1123) over corresponding links. One of the ports or an additional port may be provided as a configuration channel 1114, to enable a user or system to interface with the M-CDS device 705 and configure functionality of the M-CDS device 705, define configurations for connections and communication with the M-CDS device 705 (e.g., by host devices 1115-1122), define policies and rules that may be applied to memory-based communication channels implemented on the M-CDS device 705, configure CDS services provided by through the hardware, firmware, and/or software executed on the M-CDS device 705, among other example features.

The M-CDS device 705 also includes one or more memory elements (e.g., 1130, 1135, 1140, 1145), at least a portion of which are offered as shared memory and implement communication buffers through which buffer schemes may be applied to implement communication channels between two or more hosts (e.g., 1115-1123) through the exchange of data over the buffer(s). The portions of memory 1130, 1135, 1140, 1145 designated for use as shared memory may be presented by the M-CDS device 705 to the host devices (e.g., 1115-1122) as shared memory (e.g., using semantics of the corresponding interconnect protocol through which the host device connects to the M-CDS device 705). Corresponding memory controllers (e.g., 1131, 1136, 1141, 1146, etc.) may be provided to perform memory operations on the respective memory elements (e.g., 1130, 1135, 1140, 1145). The M-CDS device 705 may further include direct memory access (DMA) engines (e.g., 1165, 1170) to enable direct memory access (e.g., DMA reads and writes) by hosts (e.g., 1115-1122) coupled to the M-CDS device 705 and utilizing buffers for communication channels as implemented in the shared memory regions of the M-CDS memory (e.g., 1130, 1135, 1140, 1145).

One or more CPU processor cores (e.g., 1150) may be provided on the M-CDS device 705 to execute instructions and processes to implement the communication channel buffer and provide various CDS services in connection with these buffers (e.g., based on the respective configuration, rules, and policies defined for the buffer). Corresponding cache may be provided, and the processor cores 1150 may cooperate and interoperate with other processing elements provided on the M-CDS device 705, including ASIC accelerator devices 1155 (e.g., cryptographic accelerators, error correction and detection accelerators, etc.) and various programmable hardware accelerators 1160 (e.g., graphics accelerators (e.g., CPU), networking accelerators, machine learning accelerators, matrix arithmetic accelerators, field programmable gate array (FPGA)-based accelerators, etc.). Specialized processing functionality and acceleration capabilities (e.g., provided by hardware accelerators 1155, 1160, etc. on the M-CDS device 705) may be leveraged in the buffer-based communication channels provided through the memory of the M-CDS device 705, based on configurations and rules defined for the channel.

Logic may be provided on the M-CDS device 705 to implement various CDS services in connection with the buffer-based communication channels provided on the M-CDS device 705. Such logic may be implemented in hardware circuitry (e.g., of accelerator devices (e.g., 1155, 1160), functional IP blocks, etc.), firmware or software (e.g., executed by the CPU cores 1150). Functional CDS modules may thereby be implemented, such as modules that assist in emulating particular protocols, corresponding packet processing, and protocol features in a given buffer channel (e.g., providing Ethernet-specific features (e.g., Dynamic Host Configuration Protocol (DHCP)), etc.) using an Ethernet port management module, or RDMA and InfiniBand features using a RDMA and/or InfiniBand module (e.g., 1174). Various packet parsing and processing may be performed at the M-CDS device 705 using a packet parsing module 1176, for instance, to parse packets written to a communication channel buffer and performing additional services on the packet to modify the packet or prepare the packet for reading by the other device coupled to the communication channel buffer. Application management tasks may also be performed, including routing tasks (e.g., using a flow director 1178) to influence the manner in which data communicated over a buffer is consumed and routed by the domain receiving the data (e.g., specifying a process, core, VM, etc. on the domain device that should handle further processing of the data (e.g., based on packet inspection performed at the M-CDS device 705), among other examples). An application offload module 1180 may be leverage information concerning a network connection of one of the devices coupled to the M-CDS device 705 to cause data read by the device to be forwarded in a particular manner on a network interface controller or other network element on the device (e.g., to further forward the data communicated over the M-CDS device 705 communication channel to other devices over the network). In still other examples, the M-CDS device 705 may perform various security services on data written and/or read from a communication channel buffer implemented on the M-CDS device 705, for instance, applying custom or pre-defined security policies or tasks (e.g., using a security engine 1182), applying particular security protocols to the communications carried over the communication channel buffer (e.g., IPSec using a security protocol module 1184), among other example CDS services and functionality. As an example, as discussed herein, an M-CDS device may be utilized to assist in implementing a hardware-sharing service to allow various applications to utilize hardware resources of remote hardware devices in a service-based model. For instance, the M-CDS device may include a resource service management engine 1190 to manage aspects of the M-CDS device's involvement in the instantiation and delivery of service-based access to a hardware resource by an application. For instance, the resource service management may include usage tracking logic 1195 to monitor the buffers and data passing through the buffers in the delivery of the hardware resource service to track usage of a subject hardware resource by an application (e.g., for purposes of computing pricing for the application's use), among other examples.

As introduced above, a traditional IP network may be at least partially replaced using one or more (or a network of) M-CDS devices. M-CDS devices may be utilized to implement cross-domain collaboration that allows information sharing to become more intent-centric. For instance, one or more applications executed in a first domain and the transactions required for communications with other applications of a different domain may be first verified for authenticity, security, or other attributes (e.g., based on an application's or domain's requirements), thereby enforcing implicit security. Memory-based communication may also offer a more reliable data transfer and simpler protocol operations for retransmissions and data tracking (e.g., than a more convention data transfer over a network or interconnect link (which may be emulated by the memory-based communication). Through such simpler operations, M-CDS solutions can offer high-performance communication techniques between interconnecting domain-specific computing environments. Further, the memory interfaces in an M-CDS device may be enforced with access controls and policies for secure operations, such as an enabling a data-diode which offers communications in a unidirectional fashion with access controls, such as write-only, read-only, and read/write permitted. In other instances, the memory-based communication interface may enable bi-directional communication between different domains. In some implementations, separate buffers (and buffer schemes) may be used to facilitate each direction of communication (e.g., one buffer for communication from domain A to domain B and another buffer for communication from domain B to domain A). In such cases, different policies, CDS services, and even protocols may be applied to each buffer, based on the disparate characteristics and requirements of the two domains, among other example implementations. Generally, these memory-based communication interfaces can be a standard implementation and may also be open-sourced for easier use, community adoption, and public participation in technology contributions without compromising the security and isolation properties of the data transactions. The open implementation also provides transparency of communication procedures over open interfaces to identify any security vulnerabilities.

Traditional communication channels may utilize protocols, which define at least some constraints and costs in achieving compatibility between the connected devices and applications that are to communicate over the channel. An M-CDS may enable support for application-defined communication protocols over open interface definitions (and open implementation), allowing customized communication solutions, which are wholly independent of or at least partially based on (and emulate) traditional interconnect protocols. For instance, application-defined communication protocols may enable applications to create their own datagram format, segmentation, encryption, and flow control mechanisms that are decoupled from the protocols used in the M-CDS interfaces (connecting the M-CDS device to host devices) and memory buffers. In some instances, an M-CDS solution only provides the domain systems with physical memory space to communicate and allows the domain systems to specify and define how the systems will communicate over M-CDS memory, with the M-CDS device providing logic that may be invoked by the application-specific definition to perform and enforce specified policies or features desired by the domain systems, among other examples.

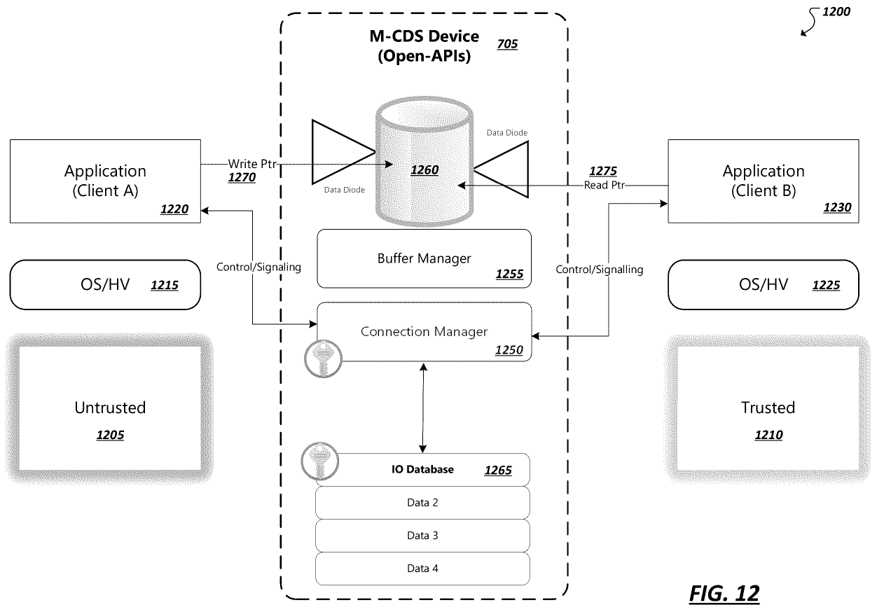

An example M-CDS device may be utilized to implement an M-CDS-based I/O framework (IOFW). The M-CDS device may be incorporated in a system such as that illustrated in the example of FIG. 12. FIG. 12 shows a simplified block diagram 1200 of the system, including an M-CDS device 705 coupled to a first client 1220 (associated with an untrusted domain 1205) and a second client 1230 (associated with a different, trusted domain 1210). In this example, the clients 1220, 1230 may be respective applications run in corresponding operating environments 1215, 1225 (e.g., respective operating systems, hypervisors, containers, etc.) associated with domains 1205, 1210. In other cases, clients may be other types of processes, services, threads, or other software entities. The clients (e.g., 1220, 1230), although provided through independent and disparate domains (e.g., 1205, 1210) may nonetheless be beneficially coupled using an M-CDS to allow the clients to co-function and provide a beneficial service or function (e.g., implement a security application, a defense application, an automotive application, a healthcare application, or a financial application, among other examples.

An IOFW provides a framework for software components in the respective domains of computing nodes to interface with shared memory based inter-process communication (IPC) channels, which are either physical or virtual functions, in a uniform and scalable manner. More specifically, an IOFW provides a framework for establishing and operating a link between any two functional software modules or clients (e.g., applications, drivers, kernel modules, etc.) belonging, in some cases, to independent domains of computing nodes. As an example, a process A (e.g., 1220) of domain X (e.g., 1205) may be linked with a process B (e.g., 1230) of domain Y (e.g., 1210) via a communication channel implemented on a M-CDS device 705. While clients communicating over an IOFW of an M-CDS device, may, in many cases, belong to independent domains (e.g., of independent computing nodes), communication over an M-CDS device (e.g., 705) is not limited to clients operating in different domains. For instance, two clients can belong to the same domain or different domains. An M-CDS device 705 may implement an IOFW that provides a mechanism for setting up both an end-to-end connection and a communication channel buffer (e.g., according to a buffer scheme definition) to support data transfer. To implement the IOFW, an M-CDS device 705 may decouple control (e.g., for connection setup) from the data plane (e.g., for data transfer).

Continuing with the example of FIG. 12, in some implementations, an example M-CDS device 705 may include a connection manager 1250 and a buffer manager 1260, the connection manager 1250 embodying those hardware and logical elements of the M-CDS device 705 that are to implement the control plane of the connection (e.g., to establish and configure the communication channel) and the buffer manager 1255 implementing the data plane using a buffer 1260 implemented in the shared memory of the M-CDS device 705. The connection manager 1250 may interface with respective host devices and clients (e.g., 1220, 1230) to identify requirements, policies, and schemes for a communication channel to be implemented between the clients. The connection manager 1250 may coordinate the negotiation, configurations, and opening of the channel, allowing communication to commence over a buffer implemented in the M-CDS device shared memory that is sized and governed in accordance with the configuration determined using the connection manager 1250. Policies, client identities, protocol definitions, and buffer schemes may be maintained in a database 1265.

In some implementations, an M-CDS device connection manager facilitates the connection setup between clients. Each client (e.g., 1220, 1230) may be expected to request a desired buffer scheme for transmission and receiving, respectively, along with the target clients for the connections. The connection manager 1250, in coordination with the M-CDS database 1265, permits the requested connection by setting up the buffer schemes that will govern the buffers (e.g., 1260) implemented in the M-CDS shared memory to implement a communication channel between the clients (e.g., 1220, 1230). Once the connection is set up, the connections' states, along with tracking information, may be updated to the database 1265 (among other information) to keep the real-time IOFW statistics for the connection (e.g., which may be used by the buffer manager 1255 in connection with various CDS services (e.g., QoS management) provided for the channel). The connection manager 1250 allows the handover of channel ownership so that connection services can be offloaded to other clients (e.g., other services or threads) as permitted by the security policies or other policies of the respective computing domains (e.g., 1205, 1210). The connection manager 1250 may allow suspension of the active connection between two channels (e.g., two channels between clients A and B) to establish a new active connection with another client (e.g., between client A and another client C). In this example, when clients A and B want the resumption of service, the connection between clients A and B can be resumed without losing the previous states of the previously established channels (e.g., during the suspension of the connection between clients A and B), while operating the connection in the M-CDS device 705 between clients A and C, among other illustrative examples. Similar to the client registration for setting up the buffer schemes, the connection manager 1250 may also facilitate the de-registration of channels by one or more of the involved clients, to retire or disable a corresponding buffer, among other examples.

In some implementations, the buffer manager 1255 provides the framework for creating new buffer schemes to define communication channel buffers for use in implementing M-CDS communication channels. Defined buffer schemes may be stored, for instance, in database 1265 and may be recalled to work as a plugin in subsequent communication channels. Buffer schemes may also be configured dynamically. The buffer manager may support various buffer schemes which suit the unique requirements of the clients and new buffer schemes may be introduced to register at run-time. A variety of buffer attributes (e.g., buffer type, buffer size, datagram definitions, protocol definition, policies, permissions, CDS services, etc.) may be specified for a buffer in a buffer scheme and potentially limitless varieties of buffers schemes and buffers may be implemented to scale an IOFW platform for new future requirements corresponding to future clients, such as buffer features supporting Time Sensitive Networking (TSN) Ethernet, Dynamic Voltage and Frequency Scaling (DVFS), global positioning system (GPS) timing use cases to share across domains, among a myriad of other example features.

Buffer schemes define the attributes of a buffer to be implemented within the shared memory of a M-CDS device. A defined buffer handles the movement of data in and out of shared memory, thereby allowing clients (e.g., 1220, 1230) with access to the buffer (e.g., 1260) to exchange data. The buffer 1260 may be configured and managed (e.g., using the buffer manager 1255) to emulate traditional communication channels and provide auto-conversion of schemes between the transmit function of one client (e.g., 1220) to the receive function of the corresponding other client (e.g., 1230) coupled through the buffer 1260. In some implementations, within a buffer, clients (e.g., 1220, 1230) can choose different buffer schemes, for example, a data Multiplexer (MUX) can read data in a serial stream and output high-level data link control (HDLC) frames in a packet stream. On the contrary, a data serializer may convert the parallel data stream to the serial stream using a buffer according to a corresponding buffer scheme. Conversion from one buffer scheme to another may also be supported. For example, an existing or prior buffer scheme that is configured for serial data transmission may be converted to instead support packet data, among other examples. In some implementations, the buffer scheme defines or is based on a communication protocol and/or datagram format. The protocol and data format may be based on an interconnect protocol standard in some instance, with the resulting buffer and M-CDS channel functioning to replace or emulate communications over a conventional interconnect bus based on the protocol. In other instances, a buffer scheme may be defined according to a custom protocol with a custom-defined datagram format (e.g., a custom packet, flit, message, etc.), and the resulting buffer may be sized and implemented (e.g., with corresponding rules, policies, state machine, etc.) according to the custom protocol. For instance, a buffer scheme may define how the uplink and downlink status is to be handled in the buffer (e.g., using the buffer manager). In some instances, standard services and policies may be employed to or may be offered for use in any of the buffers implemented in the M-CDS device to assist in the general operation of the buffer-implemented communication channels. As an example, a standard flow control, load balancing, and/or back-pressuring scheme may be implemented (e.g., as a default) to the data and/or control messages (including client-specific notification schemes) to be communicated over the buffer channel, among other examples.

The database 1265 may be utilized to store a variety of configuration information, policies, protocol definitions, datagram definitions, buffer schemes, and other information for use in implementing buffers, including recalling previously used buffers. For instance, database 1265 may be used for connection management in the M-CDS device 705 to facilitate connection setup, tracking of connection states, traffic monitoring, statistics tracking, and policy enforcement of each active connection. Indeed, multiple concurrent buffers of varying configurations (based on corresponding buffer schemes) may be implemented concurrently in the shared memory of the M-CDS device 705 to implement multiple different concurrent memory-based communication channels between various applications, processes, services, and/or threads hosted on two or more hosts. The database 1265 may also store all information about authorized connections, security policies, and access controls, etc. used in the establishing the connections with the channels. Accordingly, the connection manager 1250 may access the database 1265 to save client-specific information along with connection associations. The access to the connection manager in the M-CDS device 705 may be enabled through the control plane of the CDS ecosystem, independent of the host node domains (of hosts coupled to the M-CDS device 705), among other example features.

In some implementations, an M-CDS device may support direct memory transactions (DMT) where the direct mapping of address spaces are directly between independent domains coupled to the M-CDS device such that applications can directly communicate over shared address domains via the M-CDS device. Further, Zero-Copy Transactions (ZCT) may be supported using the M-CDS DMA engine to allow the M-CDS device to be leveraged as a “data mover” between two domains where the M-CDS DMA function operates to move data between two domains (through the independent M-CDS device 705) without requiring any copies into the M-CDS local memory. For instance, the DMA of the M-CDS device 705 transfers the data from the input buffer of one client (e.g., Client A (of domain X)) to the output buffer of a second client (e.g., Client B (of domain Y)). The M-CDS device may also implement packet based transactions (PBT), where the M-CDS device exposes the M-CDS interfaces as a virtual network interface to the connecting domains such that the applications in their respective domains can use the traditional IP network to communicate over TCP or UDP sockets using the virtual network interface offered by the M-CDS services (e.g., by implementing a first-in first-out (FIFO) queue in the shared memory of the M-CDS device) with normal packet switching functionalities, among other examples.

The M-CDS device may enforce various rules, protocols, and policies within a given buffer implemented according to a corresponding buffer scheme and operating to facilitate communication between two domains coupled to the M-CDS device. As an example, in some instances, the M-CDS device 705 may enforce unidirectional communication traffic in a buffer, by configuring the buffer such that one of the device is permitted read-only access to data written in the buffer, while the other device (the sender) may write (and potentially also read) data to the buffer. Participating systems in an M-CDS communication channel may be provided with a pointer or other memory identification structure (e.g., a write pointer 1270, a read pointer 1275, etc.) to identify the location (e.g., using an address alias in the client's address space) of the buffer in the M-CDS memory (e.g., and a next entry in the buffer) to which a given client is granted access for cross-domain communication. Access to the buffer may be controlled by the M-CDS device 705 by invalidating a pointer (e.g., 1270, 1275) thereby cancelling a corresponding client's access to the buffer (e.g., based on a policy violation, a security issue, end of a communication session, etc.). Further, logic of the M-CDS device 705 may allow data written to the buffer to be modified, redacted, or censored based on the M-CDS device's understanding of the datagram format (e.g., and its constituent fields), as recorded in the database 1265. For instance, data written by a client (e.g., 1230) in a trusted domain may include information (e.g., a social security number, credit card number, demographic information, proprietary data, etc.) that should not be shared with an untrusted domain's clients (e.g., 1220). Based on a policy defined for a channel implemented by buffer 1260, the M-CDS device 705 (e.g., through buffer manager 1255) may limit the untrusted client 1220 from reading one or more fields (e.g., based on these fields identified as including sensitive information) of data written to the buffer 1260 by the trusted application 1230, for instance, by omitting this data in the read return or modifying, redacting, or otherwise obscuring these fields from the read return, among other examples.

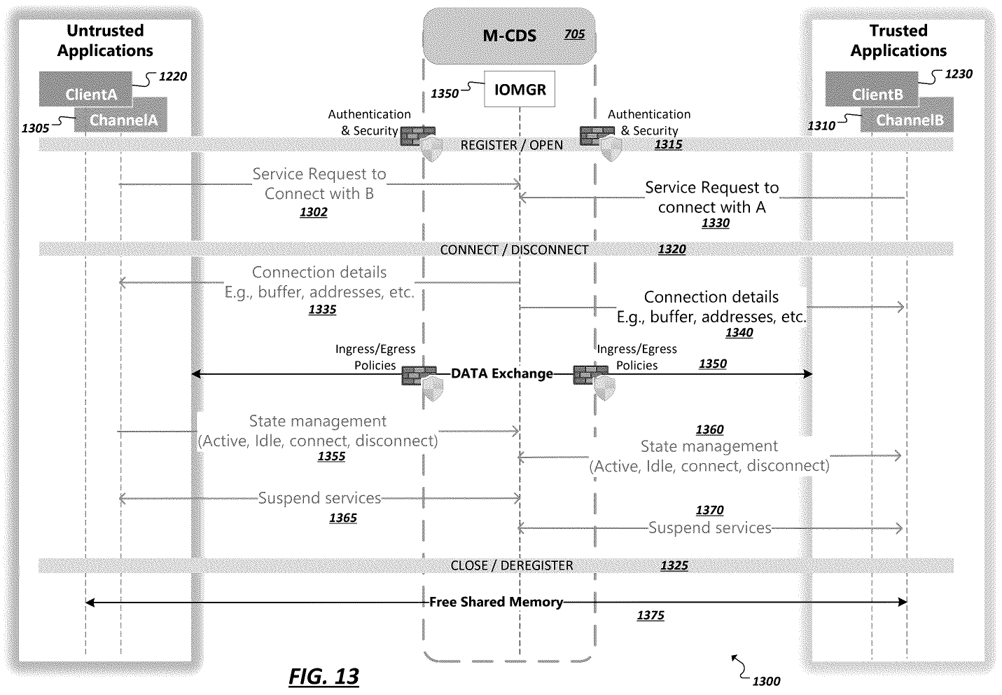

FIG. 13 is a flow diagram 1300 illustrating an overview of the example end-to-end M-CDS operation for two clients, namely client A 1220 and client B 1230, belonging to untrusted 1205 and trusted 1210 domains, respectively, utilizing a M-CDS device 705 for the I/O framework. In this example, client A 1220 sends a request 1302 to the M-CDS device 705 to establish a connection with client B 1230 through the connection manager 1250 of the M-CDS device 705. In some implementations, the flow may be similar to Inter Process Communication (IPC) over shared memory, however the operations over M-CDS involve multiple operating system (OS) domains, and hence require coordination of resources, buffer, and connection management as an independent function of the M-CDS solution. For instance, a Registration phase 1315 may be utilized to register each of the participating clients (e.g., 1220, 1230) with the connection manager 1250, a Connection State Management phase 1320 to control the memory-based links status (e.g., to move between active and deactivated (or idle) link states), and a Deregistration phase 1325 to tear down the buffers established in the M-CDS device memory for the link and completing deregistration of the communication channels (e.g., 1305, 1310) of the clients (e.g., 1220, 1230) (e.g., to free up the shared memory for other buffers and communication channels between clients on different domains).

In one example, a Registration phase 1315 may include requests by each of the two or more clients (e.g., 1220, 1230) that intend to communicate on the M-CDS communication channel, where the clients send respective requests (e.g., 1302, 1330) registering their intent to communicate with other clients with the M-CDS 705. The connection manager 1250 may access and verify the clients' respective credentials and purpose of communication (e.g., using information included in the requests and validating this information against information included in the M-CDS database). For instance, an authentication may be performed using the M-CDS-control plane before a given client is permitted to establish communication links over M-CDS memory interfaces. Each established communication link that is specific to the client-to-client connection may be referred to as a “memory channel” (e.g., 1305, 1310). Further, admission policies may be applied to each client 1220, 1230 by the connection manager 1250. In some implementations, the Registration phase 1315 may include an IO Open function performed by the M-CDS device 705 to enables the creation of memory channels (e.g., 1305, 1310) dedicated to each communication link of the pair of clients, in the case of unicast transactions. In the case of multicast/broadcast transactions, the M-CDS device 705 registers two or more clients and acts as a hub where the data from at least one source client (writing the data to the buffer) are duplicated in all the received buffers granted access to the respective destination clients registered on these channels, among other examples.

In a Connection State Management phase 1320 an IO Connect function may be performed by the connection manager 1250 to notify all of the clients registered for a given communication channel to enter and remain in an active state for the transmission and/or reception of data on the communication channel. While in an active state, clients may be expected to be able to write data to the buffer (where the client has write-access) and monitor the buffer for opportunities to read data from the buffer (to receive the written data as a transmission from another one of the registered clients). In some instances, a client can register, but choose not to send any data while it waits for a requirement or event (e.g., associated with an application or process of the client). During this phase, a client can delay the IO Connect signaling after the registration process. Once an IO Connect is successful, then the receiving client(s) is considered ready to process the buffer (e.g., with a closed-loop flow control mechanism). Data may then be exchanged 1335.

The Connection State Management phase 1320 may also include an IO Disconnect function. In contrast to IO Connect, in IO Disconnect, the connection manager 1250 notifies all clients (e.g., 1220, 1230) involved in a specific memory channel to transition to inactive state and wait until another IO Connect is initiated to notify all clients to transition back to the active state. During the lifetime of client-to-client communication session over M-CDS, each participating client (e.g., 1220, 1230) in a memory channel can potentially transition multiple times between active and inactive states according to data transfer requirements of the interactions and transactions between the clients and their respective applications.

A Deregistration phase 1325 may include an IO Close function. In contrast to IO Open, the IO Close function tears down the memory reservations of the memory communication channels used to implement the buffers configured for the channel. A client can still be in the registered state, but the connection manager 1250 can close the memory communication channels to delete all the buffers that have been associated with the memory channels in order to free up the limited memory for other clients to use. Should a change in the activity or needs of the clients change, in some implementations, the memory communication channels may be reopened (through another IO Open function), before the client are deregistered. The Deregistration phase 1325 also includes an IO Deregister function to perform the deregistration. For instance, in contrast to IO Register, IO Deregister is used by the clients to indicate their intent to M-CDS device to disassociate with other client(s) and the M-CDS itself (e.g., at least for a period of time until another instance of the client is deployed and is to use the M-CDS). In the IO Deregister function, the M-CDS device clears the client's current credentials, memory identifiers (e.g., pointers), and other memory channel-related data (e.g., clearing such information from the M-CDS device database), among other examples.

In some implementations, M-CDS devices may be integrated within a multi-core processor device (e.g., a SOC or SOP) in order to implement dedicated compute isolation domains between the cores and/or other IP blocks providing compute logic (e.g., accelerators) on the device. The compute isolation domains may implement secure and non-secure processing domains, which may be protected or isolated using interconnects enhanced by one or more M-CDS devices, which are used to couple the IP blocks together (e.g., in an on-chip network). Accordingly, an M-CDS device may implement isolation by separating the interconnect into secure and nonsecure busses. Accordingly, M-CDS devices integrated within an on-chip fabric may also the compute resources of the device to be secured at the hardware level. Accordingly, different portions of the compute resources of the chip may be designated for enhanced security for processing secure workloads, while other portions (e.g., cores) are designated as unsecured or less-secured and will be used for normal or standard workloads. As but one example, a SoC utilized in an in-vehicle computing system may have its compute resources separated between cores isolated to perform critical workloads (e.g., related to autonomous driving or safety control) while other cores perform less critical workloads (e.g., relating to infotainment). As another example, an edge or server may include a SoC with M-CDS devices integrated thereon, the M-CDS devices implementing isolation between different set of IP blocks reserved to execute different virtual machines, among other examples.

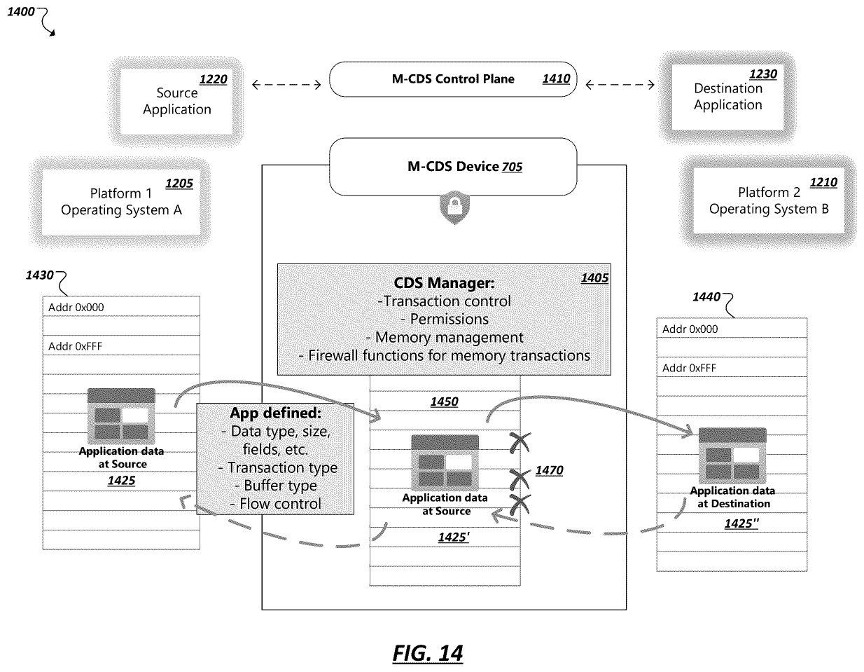

Turning to FIG. 14, a simplified block diagram 1400 is shown illustrating the example M-CDS device 705 coupled to first computing platform 1205 and a second computing platform 1210 by respective connections (e.g., point-to-point interconnect links, network channels, etc.). The operating systems of the respective computing platforms 1205, 1210 may be independent from each other and represent independent domains. All or a portion of different applications, virtual machines, application components, services, etc. (e.g., 1220, 1230) may be executed and implemented on the respective computing platforms 1205, 1210. The M-CDS device may implement a store and forward memory architecture using its local shared memory, which it can configure to implement specific memory-based communication channels subject to custom-defined (e.g., by the source and destination applications 1220, 1230 using the M-CDS control plane 1410 interfaces). The M-CDS device may thereby enforce ingress and egress policies in hardware, with a buffer scheme used to define a specific buffer for the memory channel. The buffer may be configured to adapt to a specific structure and format based on a specific datatype or datagram that is to be managed using the M-CDS device 705. In some instances, the M-CDS device may be configured to cause additional services to be provided at the M-CDS device for the memory-based communication channel corresponding to the buffer, encryption/decryption of data to be written and read out of the buffer, DMA access to the buffer, among other features. Enforcement of the policies at the M-CDS device may cause the M-CDS device to block access to particular portions of a datagram or blocking access to all or a portion of the data (e.g., shielding access to this information to a consuming platform (e.g., 1210)), among other examples.

Continuing with the example of FIG. 14, an application or VM (e.g., 1220) run within the domain (e.g., an operating environment, such as an operating environment or hypervisor) on computing platform 1205 may generate application data 1425 and may identify (e.g., through the M-CDS control plane) the nature of the data that the application 1220 will be sharing to cause a buffer to be configured (e.g., through the provision or definition of a corresponding buffer scheme) in the shared memory 1450 of the M-CDS device 705 that is tuned to the data type (e.g., datagram format) and corresponds to the transaction type, buffer type, flow control requirements, security policies, etc. applicable to the application and/or the application data 1425. This data may be passed to the M-CDS device 705 over a connection such that the data 1425 is written from memory 1430 of the first platform 1205 to the shared memory 1450 of the M-CDS device 705 to be stored (as data 1425′) in the buffer configured in the shared memory 1450. A CDS manager 1405 executed in the M-CDS device 705 may further identify (e.g., as provisioned through the M-CDS control plane 1410 (e.g., by application 1220 and/or application 1230) the various policies that should be applied to the data 1425′ (e.g., subject to or in response to certain application contexts or conditions (e.g., the current running state of the system for that particular software agent, shared variables, configurations, system registers, etc.). The CDS manager 1405 may further include logic to implement or enforce these policies, for instance, through transaction control (e.g., identifying conditions or contexts that trigger certain policy provisions), permission management (e.g., specific to certain fields of information within the data 1425′), memory management (e.g., to block certain addresses within the shared memory 1450 corresponding to the buffer used to implement a memory-based communication channel between the two (or more) platforms (e.g., 1205, 1210)), and implement hardware-secured firewall functions for memory transactions corresponding to the memory-based communication channel. Accordingly, in some instances, the M-CDS device 705 (e.g., through its CDS manager 1405) may cause, based on specific policies defined for the buffer and data (e.g., 1425′) written to the buffer, full access to the data (to be written to memory 1440) by the destination application 1230 (and platform 1210 more generally) to be blocked (at 1470). As such, the version of the application data 1425″ retrieved or received at the platform 1210 for consumption by application 1230 may be filtered, masked, redacted, or otherwise limited by the M-CDS device 705 in accordance with one or more policies defined for the buffer, among other examples.

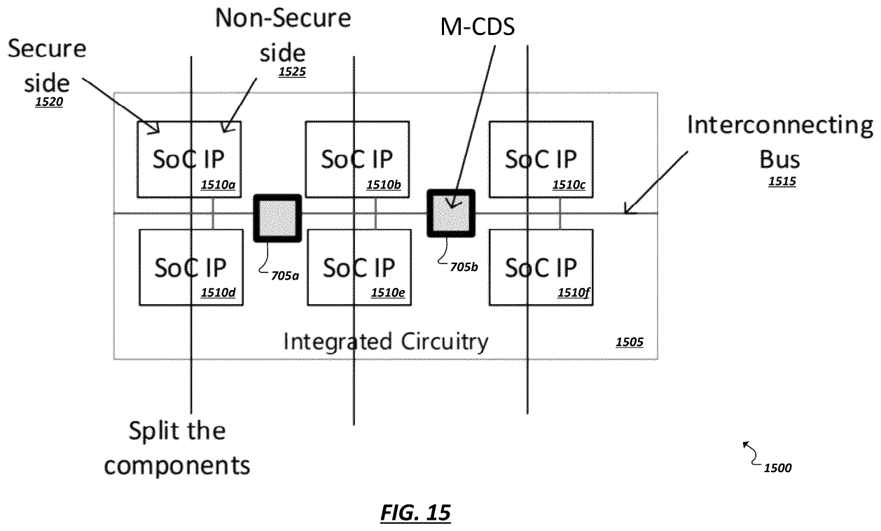

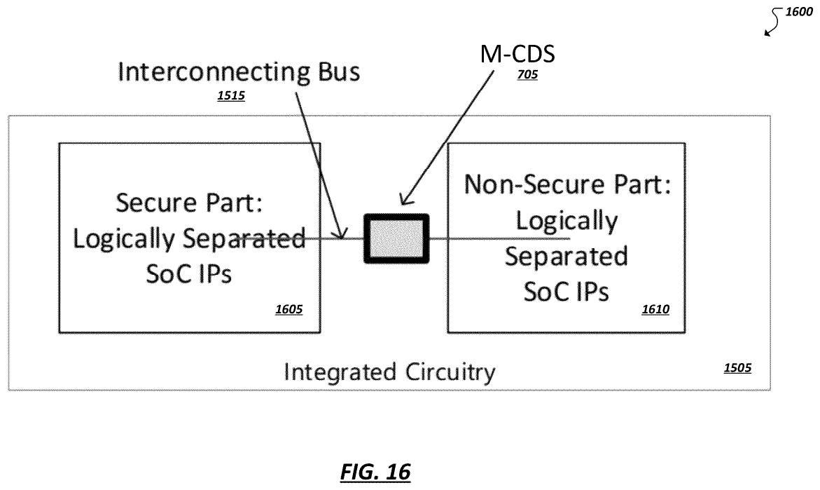

Turning to FIG. 15, a simplified block diagram 1500 is shown of an example computing system 1505 (e.g., a server system) including multiple SoC or system on package (SoP) devices (e.g., 1510a-f) interconnected using various interconnects 1520. M-CDS devices may be included on one or more of the SoC or SoP devices (e.g., 1510a-f) to programmably implement secure and unsecure “sides” or portions (e.g., 1520, 1525) of such SoC or SoP devices. Further, M-CDS devices (e.g., 705a-b) may be provided in association with the interconnects used to couple the devices 1510a-f to allow memory-based communication channels to couple the device together, such that secured communication channels may be established between a secure portion of a device (e.g., 1510a) and a second portion of another device (e.g., 1510f). Alternatively, where the other device is entirely designated as belonging to a secure domain, an M-CDS device (e.g., 705a) may be used to implement a secure memory-based communication channels between the secure portion of the device (e.g., 1510a) and the other device (e.g., 1510f) implementing a secure domain. Accordingly, a grouping of SoC device resources may be designated for handling secure workloads and another grouping of SoC device resources may be designated for handling unsecure or normal workloads by programming one or more M-CDS devices and corresponding memory-based communication channels to implement specific domain isolation between the domains implemented using these two groupings of SoC device resources. As shown in the simplified block diagram 1600 of FIG. 16, logically, multiple SoCs on a device 1505 and their multiple constituent compute resources may be grouped to logically create two different computing or security domains 1605, 1610, which may be coupled by an interconnect (or fabric or mesh of buses interconnecting the various devices) outfitted with one or more M-CDS devices (e.g., 705a-b) to enforce the separation between the domains 1605, 1610.

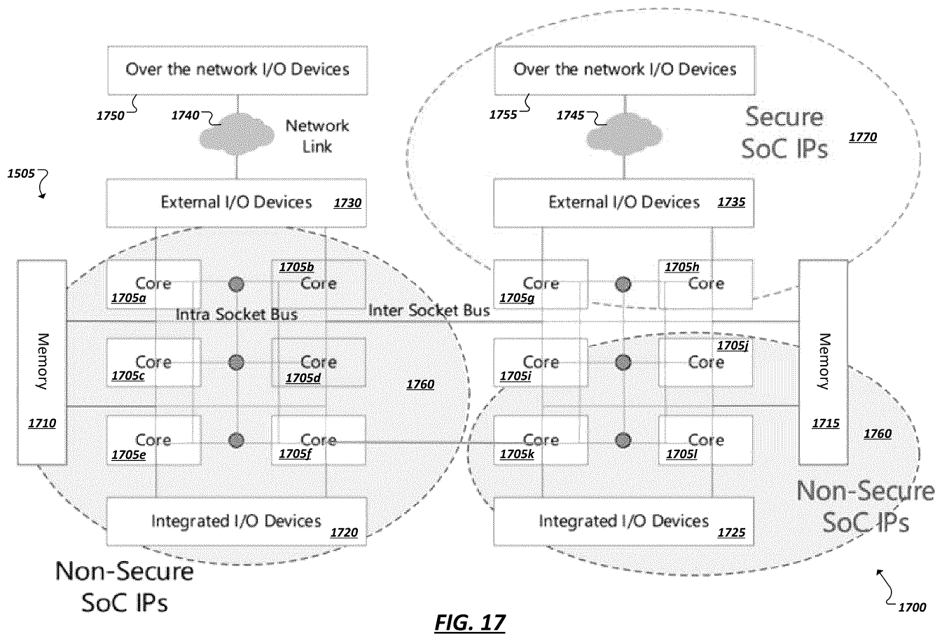

As noted above, the component compute blocks within a given SoC or SoP device may themselves be isolated even within a single SoC or SoP device to create separate secure and unsecured portions of the device. For instance, turning to FIG. 17, a simplified block diagram 1700 is shown illustrating an example computing device 1505 (e.g., a SoC or SoP device) implemented on a single die or package and including multiple IP blocks (e.g., 1705a-1705l). One or more M-CDS devices may also be provided on the device 1505 and integrated with or coupled to the on-chip interconnect fabric of the device 1505. In some implementations, the on-chip interconnect fabric may be implemented as a network on chip (NOC), among other example implementations which may be according to a variety of different network topologies and protocols. The M-CDS devices may be programmatically configured (such as discussed above) to implement isolation within the device, for instance, isolating one group of IP blocks (e.g., 1705a-f) from another (e.g., 1705g-l) and even one portion of the interconnect fabric from another.

In the example of FIG. 17, one or more devices (e.g., 1505) include multiple cores (or other IP blocks) 1705a-l. For instance, in one implementation, cores 1705a-f are implemented on a first SoC and cores 1705g-l are implemented on a second SoC coupled to the first SoC by an inter-socket bus or other interconnect. In another example implementations, all of cores 1705a-l are included on a single SoC and interconnect by an on-chip fabric, among other example implementations. Interconnect buses may implement on-chip networks to interconnect the cores, as well as other system components, such as memory elements (e.g., 1710, 1715), I/O devices (e.g., 1720, 1725, 1730, 1735, etc.), and enable interconnection (through corresponding I/O ports) of the system with external devices (e.g., 1750, 1755) over one or more networks (e.g., 1740, 1745). An interconnect fabric may include various routers and accompanying logic may direct data between the cores and components of the device. Further, in this example, M-CDS devices may be integrated on the interconnect fabric at various points and on various physical buses of the interconnect to enable a variety of configurations of the device (e.g., to implement different logical sides of or isolated domains within the device).

A controller or orchestrator (e.g., associated with and/or integrated with BIOS, a board management controller (BMC), or other system controller) may configure one or more of the M-CDS devices to implement one or more memory-based communication channels subject to specific, defined policies (e.g., in accordance with a corresponding buffer scheme). The controller may further configure routing on the interconnect (e.g., through the configuration a corresponding routing table) to cause certain data destined for a given IP block or group of IP blocks to be routed over a specific one of the M-CDS devices configured to implement a given memory-based communication channel. In this manner, the interconnect and the integrated M-CDS devices may be utilized to enforce the creation of certain isolated compute domains even within the same device. For instance, a particular one of the M-CDS devices may be configured to operate (e.g., during a first window of time or in connection with the execution of a particular workload that would benefit from the configuration) to implement a memory-based communication channel that implements a secured communication channel to cores 1705g and 1705h, effectively segregating or isolating these IP blocks (e.g., 1705g,h) from other IP blocks (e.g., 1705a-f, 1705i-l) on the device, as well as a portion of the overall interconnect fabric (e.g., downstream from one or more M-CDS devices configured on the interconnect to control the flow of data and instructions to the IP blocks).

In the particular example of FIG. 17, M-CDS-based communication channels are configured to implement security policies to cause a portion of the compute blocks (e.g., cores 1705g, 1705h) to represent a secured compute domain 1770, while the remaining compute blocks implement a normal or unsecured compute domain 1760. For instance, an M-CDS device may be configured to implement a data diode to permit only particular data to be passed to the cores 1705g, 1705h for processing within the secured compute domain 1770 (e.g., and further blocking data other than the particular data from entering a section of the interconnect fabric included in the secured compute domain 1770 (e.g., attached to the cores 1705g, 1705h). Accordingly, while the groups of compute blocks are so configured, an operating system, hypervisor, or other system software may cause certain workloads (e.g., that would benefit from enhanced security) to be executed within the secured compute domain 1770 and causing other workloads to be executed on the normal compute domain 1760, with the configured M-CDS enforcing this separation and isolation of the secured compute domain 1770 from the remaining compute resources of the device 1505, among other examples. Indeed, a wide variety of different configurations and policies may be applied within the device using various M-CDS devices integrated on the device's interconnect fabric to implement isolated compute domains within the device 1505 and these configurations may change over time as M-CDS devices retire previous configurations (e.g., buffer schemes) and reconfigure M-CDS devices to implement other, different memory-based communication channels (e.g., with their own respectively defined policies). As such, a given core (e.g., 1705b) or other compute block or IP block on the device 1505 may be isolated from other IP blocks under one configuration (e.g., during one window of time or during processing of a given workload or application) based on configuration of an M-CDS device and later be included in a different compute domain (e.g., an unsecured compute domain or a compute domain subject to different policies and using a different M-CDS-enabled communication channel) and compute domains can include changing combinations of constituent IP blocks based on these changing configurations, and so on, among other examples.

On an example SoC or SoP, a variety of IP blocks may be coupled to the interconnect fabric as well as one or more M-CDS devices. M-CDS devices may be coupled to the interconnect to implement traffic control at a variety of different levels, including at the primary bus, secondary bus, tertiary bus, on a network-on-chip, etc. M-CDS devices may be located on the interconnect strategically to implement various isolated compute domains between computing devices or even internally between hardware blocks of a computing device, among other examples.

As introduced above, an M-CDS device may be utilized to implement one or more memory-based communication channels to create, on a single device (e.g., a SoC), logically separate secure and non-secure domains, where a secure and non-secure enabled interconnect, implemented through a configured M-CDS, may be leveraged to manage access and enforce security policies between these domains. A secure domain may be used, for instance, for processing sensitive data, running trusted applications, and managing keys. The components in this domain may include secure processors, accelerator IP blocks, memory, and peripherals that handle sensitive data, among other examples. A non-secure domain may be used for less sensitive applications. Components here can include non-secure processors, memory, and peripherals that do not require the same level of protection. The interconnect of the device may include M-CDS devices to enforce access control policies between secure and non-secure domains. For instance, in one example implementation, an interconnect protocol that supports TrustZone or similar technology for hardware-based security partitioning, may be used on an on-chip interconnect with integrated M-CDS. For instance, the protocol may allow transactions or data to be tagged as belonging to specific isolated compute domains (e.g., a secure domain or a non-secure domain). Such tagging may be performed, for instance, based on an application to which the data pertains, an identity of the originating component, among other examples.

In one example, configuration of an M-CDS device to implement a memory-based communication channel to create isolation between groups of compute elements on a device can include the definition of specific access policies for the memory-based communication channel (e.g., defining secure/non-secure access policies for sender and receiver on the channel). In one example, the system may include Address Space Controllers (ASCs) or Security Controllers (SCs) at various points on the interconnect. Policies and/or buffer schemes for the channel may define which components (e.g., CPUs or DMA controllers) are allowed to initiate secure transactions and which can initiate non-secure transactions. The policies can further (or instead) define which components (e.g., memories and peripherals) can accept secure transactions, non-secure transactions, or both. The configuration of the M-CDS device(s) may result in some components belonging in one defined compute domain, while other components belong to another compute domain (e.g., isolated from the other domain). For instance, a security domain may be created where a Secure processor or secure DMA controller within the domain can initiate transactions marked as secure, and other consuming components, such as a memory regions, secure peripherals, or secure I/O interfaces only able to accept secure transactions or have a secure/non-secure attribute, among other examples.

In one example implementation, M-CDS devices integrated on an interconnect fabric of a multi-component device may be leveraged, such as discussed above, to flexibly configure isolated compute domains on the device, such as secure and non-secure domains. For instance, separate memory and peripheral regions may be allocated for each of the secure and non-secure domains. For instance, RAM can be partitioned into secure and non-secure areas, and secure peripherals can be restricted to secure controllers only. The M-CDS devices may be configured to implement an interconnect enforcing the desired isolation, where the interconnect, through the M-CDS buffer schemes, reject any non-secure access attempts to secure resources. In some implementations, the secure compute domain may be leveraged to implement a secure boot and trust zone. For instance, a secure boot may ensure that only verified, trusted software runs in the secure domain. A trust zone extension may be used to configure a trust zone to enforce the separation of secure and non-secure execution environments. The trust zone protocol may separate the processor's execution into secure and non-secure workloads and data, as controlled by a secure monitor. With the separate compute domains instantiated through the M-CDS configuration on the interconnect fabric, software and middleware may be set up to effectively use the created secure and non-secure domains. For instance, the operating system of the corresponding system may be configured to include a Real-Time Operating System (RTOS) or a trusted OS in the secure domain to handle sensitive tasks and manage secure resources. In some cases, security middleware may be used to implement a security framework to handle secure communications, cryptography, and access control. In some implementations, an orchestrator subsystem, in addition to configuring the M-CDS memory channels, software, and security features may additionally include testing and validation logic to conduct one or more tests to ensure the separation is enforced. Tests can include testing both secure and non-secure paths created by the M-CDS configurations independently to ensure no unauthorized access between domains. Further, testing can include the performance of security assessments, such as threat modeling and penetration testing, to verify the effectiveness of the domain separation, among other example tests. If the test results are successful in validating the effectiveness of the domain separation, workloads may be delivered to the cores and IP blocks in the respective compute domains for execution.

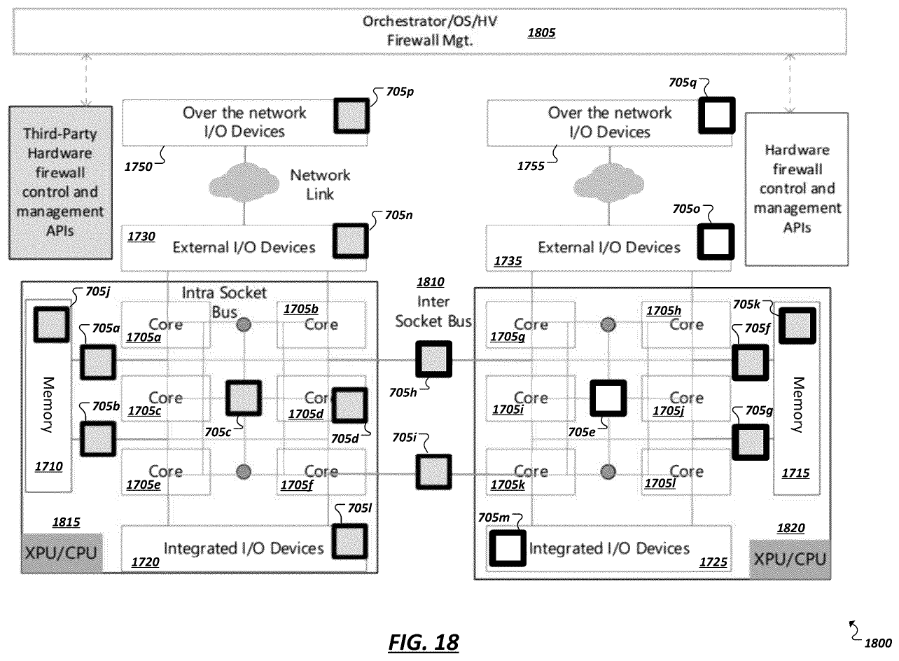

Turning to FIG. 18, a simplified block diagram 1800 is shown of an example implementation of a computing system, including multi-component computing devices 1815, 1820 coupled in a device (e.g., on a card, board, rack, etc.) by an inter-socket bus 1810. The respective multi-component devices 1815, 1820 (e.g., SoC devices) may include multiple hardware blocks (e.g., 1705a-f and 1705g-l) and respective on-chip interconnects, which interconnect the hardware blocks (e.g., 1705a-l) together and with other components of the system (e.g., memory blocks (e.g., 1710, 1715), I/O devices (e.g., 1720, 1725), hardware accelerator blocks, etc.). In this example, a set of M-CDS devices (e.g., 705a-q) may be provisioned at different points within the system to couple to various interconnect busses within the system. For instance, on-chip interconnects may include one or more M-CDS devices (e.g., 705a-g), some on-chip components (e.g., 1710, 1715, 1720, 1725, etc.) with ports coupling the components to the interconnect fabric of an SoC (e.g., 1815, 1820) may include M-CDS devices (e.g., 705j-m), for instance, as embedded or integrated M-CDS devices (e.g., in a memory subsystem or I/O device). External I/O devices (e.g., 1730, 1735) may also include M-CDS blocks (e.g., 705n-q) to which the SoC devices (e.g., 1815, 1820) may couple, among other examples.

In some implementations, an orchestrator or management subsystem (e.g., 1805) may be provided for a system and used to direct the implementation of a particular, temporary partitioning of the hardware resources of a system through configuration of one or a combination of M-CDS devices (e.g., 705a-q) provided on the system. The orchestrator 1805 may be implemented as a software-implemented or firmware-implemented sub-system. In some cases, the orchestrator 1805 may be implemented in or in association with the Basic Input/Output System (BIOS), OS, or BMC of the system. The orchestrator 1805 can discover the M-CDS devices (e.g., 705a-q) available throughout the system, as well as the hardware blocks (e.g., 1705a-l, 1710, 1715, 1720, 1725, 1730, 1735, etc.) coupled to the interconnect(s) of the system. The orchestrator 1805 may further identify a specific configuration to apply to the system to implement isolated compute domains on the system using one or more of the M-CDS devices 705a-l. During “normal” or standard operation, M-CDS devices may be configured to operate as standard buffers on the interconnect that allow all traffic to indiscriminately pass through (e.g., based on native routing tables, flow control, and other protocol attributes). In such instances, all of the hardware blocks may effectively “belong” to the same domain and may be used to execute a given operating system and various programs using the resources and logic provided through the hardware blocks. In other instances, the orchestrator may change the configuration of the system to implement, at least temporarily, an architecture with two or more isolated compute domains using the hardware blocks on the systems, even subdividing compute blocks (e.g., cores 1705a-f) on the same multi-component device (e.g., SoC 1815).

In one example, the orchestrator 1805 may determine that isolated compute domains should be established on the platform managed by the orchestrator. The reconfiguration of the platform may, in some implementations, be based on the identification of a workload, application, client, or other event, where the use of isolated compute domains may be beneficial (e.g., or even required in the case of a specialized workload requiring the application of heightened security or other policies). For instance, in one example, the orchestrator may determine a subset of the hardware resources (e.g., cores 1705g-j, external I/O device 1735, etc.) of the system to include in a particular compute domain. To implement this isolation, the orchestrator 1805 may send instructions to one or more M-CDS devices (e.g., 705e, 705m, 705o, 705q) to create one or more buffers (e.g., a buffer in each of the send and receive directions) to implement secured memory-based communication channels at the M-CDS devices to enforce policies corresponding to the domain isolation such that only certain data and workloads are allowed to pass into or out of the isolated compute domain. In some implementations, the orchestrator 1805 may select, include, or otherwise identify particular buffer schemes to be used by the respective M-CDS devices (e.g., 705e, 705m, 705o, 705q, etc.) to implement the desired memory-based communication channels. The orchestrator 1805 may verify proper configuration of these buffer-based communication channels. The orchestrator 1805 may configure the interconnect (e.g., and associated routing tables) to force data bound to one of the components (e.g., cores 1705g-j, external I/O device 1735, etc.) included in the isolated compute domain to be directed over one of the corresponding, configured M-CDS devices (e.g., 705e, 705m, 705o, 705q). Upon configuring the domain isolation through the selected M-CDS devices, the orchestrator 1805 may perform validation tests to ensure proper isolation of the domain and application of specific policies that may be applied to the domain (e.g., and enforced at the M-CDS device buffers). Upon validating the separations, the orchestrator 1805 may trigger or allow defined software (e.g., OSes, VMs, application, etc.) to be run on the isolated compute domain, while other software is executed outside the compute domain on the remaining hardware blocks of the system. After a time (e.g., corresponding to the completion of a particular workload or execution of a given application, etc.), the orchestrator 1805 may identify that the need or request for the isolated compute domain has been fulfilled and may “tear down” the domain by reconfiguring or cancelling the buffers implemented on the M-CDS devices to implement the isolation. At a later time, the orchestrator 1805 may orchestrate the creation of an entirely different separation of the IP blocks in the system (e.g., using different components, M-CDS devices, etc.) to implement another different isolated compute domain or re-instantiation of a previous isolated compute domain, among other examples. Indeed, the M-CDS devices' configurability allows for potentially limitless flexibility in defining, implementing, and redefining different logical partitions and compute domains within a given system at the direction of an example orchestrator subsystem 1805.

In some implementations, platform management hardware may incorporate M-CDS hardware and implement one or more functions of a baseboard management controller (BMC), BIOS, or other SoC management features. The platform manager block may interface with orchestrators used to orchestrate the implementation of distributed software system, such as cloud-based applications, edge applications, virtualization of hardware functions, and other tasks. The platform manager may have special hooks across the SoC to receive telemetry (e.g., collected from the various IP blocks on the SoC), perform dynamic configurations, and communicate with other platform managers, fleet managers, etc. of other platforms used in the implementation of an application, among other examples. The platform manager may have I/O capabilities, access to network controllers and interconnect fabric of a corresponding platform, and may additionally possess I/O capabilities to access other devices external to the platform (e.g., to insert a USB for booting an OS, over a network connections, extending services from cloud management).

As noted above, M-CDS devices may be utilized and combined to assist in facilitating interactions and resource sharing between multiple devices on a platform or between platforms. For instance, some applications may include computational tasks involving the large and temporary use or need for resources that may not be present on a given host device. Indeed, in some applications, resources (e.g., compute resources, memory resources, networking resource, I/O resources, specialized hardware logic or acceleration resources, etc.) may be demanded that involve the aggregation of resources from multiple devices or hosts in order to meet the temporary resource requirements for a given application or workload. In some implementations, I/O extensions may be provided in association with one or a network of M-CDS devices to facilitate the aggregation and sharing of hardware resources available on one or multiple computing devices external to the host device executing an application corresponding to the workload that is to use these resources. Such I/O extensions may be leveraged to implement such hardware resource sharing seamlessly and dynamically (e.g., allowing underutilized or idle hardware resources of one or more external hosts in a network to be claimed and utilized opportunistically), among other example features.

“Democratization” of computing has emerged as a sought after goal of cloud providers, network service providers, and application developers to improve and better commercialize computing hardware and implement hardware-as-a-service (HaaS) solutions. In compute democratization, computing hardware may be provided for public utilization, through standardized interfaces, software modules, and service agreements. Democratization of hardware may involve providing flexibility in reconfigurability of the hardware resources to the specific needs of an application that is to use the hardware. Some hardware may include IP blocks and hardware components that have hardware-features that are common to multiple packages/system, but are fused off based on customers (e.g., infrastructure vendors) specifications. Modern SOCs are being developed as feature-rich platforms with new innovative functionality to appeal to a broad applications space. These can be made available commodity compute nodes and offer services as democratized compute nodes. A significant number of hardware components and features in current and future hardware IP blocks may not be activated in the actual silicon package, but can be offered directly to users and applications on-demand in future systems. or to ESP's when they are ready to use the features.

Current solutions for hardware democratization may employ “Anything-as-a-Service” models, which are often limited, however, to the specific Service Level Agreements (SLAs) between user applications and cloud service providers. As such, the participation of SoC owners and platform owners in such “service”-type models is limited. Enabling revenue sharing at more granular levels may foster further democratization of hardware. For instance, an incremental revenue generating model may be implemented for hardware manufactures by allowing hardware manufactures to offer hardware-features and hardware-components directly to applications and users on a democratized hardware platform.—revenue sharing which is essential to the democratized compute hardware. Further, on-demand application requests for hardware functions (e.g., provided on hardware external to the application's host) may be provided to allow applications to enhance their performance based on “on-demand” requests for more granular hardware capabilities offered on compute platforms. Accordingly, such ecosystem may incentivize the development of platforms that can be reconfigured with specialized hardware components, hardware acceleration, and configurable hardware features (e.g., operational frequency adjustment, etc.) that can further enhance user application performance, among other example features. In an improved system, applications may more directly interact with hardware platform capabilities and the providers of the corresponding hardware blocks to realize the true potential of compute democratization, with revenue sharing allowing an external service provider (ESP) or cloud service provider to not need to buy or pay the full price for more specialized and advanced features (e.g., which may be enjoyed by innovative applications and allow such innovative technology a faster path to adoption and utilization), by allowing the providers of such IP blocks to be paid directly by application users through a hardware democratization or HaaS model, among other example features and benefits.

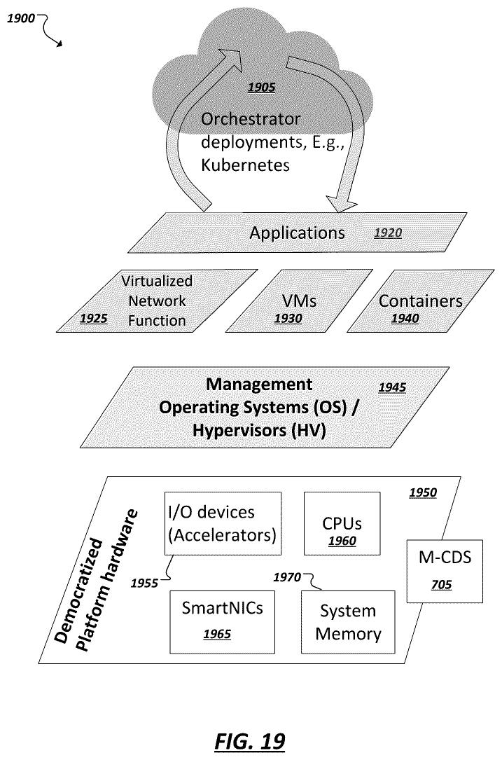

In some implementations, one or more M-CDS devices may be leveraged to assist in implementing hardware democratization services and associated granular hardware resource sharing and management. In some implementations, system software may be enhanced to leverage the M-CDS-based functionality, by interacting with hardware to enable applications to interact with hardware owners in coordination with compute service providers. Turning to FIG. 19, a simplified block diagram 1900 is shown illustrating an example computing architecture and the various layers or components, including computing platforms, OS, and applications used to implement a software solution. A set of hardware devices (e.g., 1950) may be present on a variety of different computing devices in a network. The hardware devices 1950 may be instrumented with various hardware functionality and circuitry blocks to implement various hardware-based functionality, such as compute functions (e.g., CPUs 1960), memory functions (e.g., through memory devices 1970), I/O functions (e.g., through I/O devices 1955), networking functions (e.g., through NIC devices 1965), AI compute (e.g., inference, training, matrix multiplication, etc.), tensor math acceleration, encryption/decryption, compression/decompression, among other examples. Applications (e.g., 1920) may be developed to use the functionality of the set of hardware devices 1950.

In the example of FIG. 19, an orchestrator system 1905 may be provided to assist in orchestrating and collection of devices that are to be used in connection with various applications, services, etc. that may be executed in the system. Virtual functions (e.g., 1925) (e.g., SR-IOV, SIOV, etc.), virtual machines (e.g., 1930), software containers (e.g., 1935), etc. may be used and applications and workloads may be use and run inside of such elements. System management software (e.g., 1940), such as an operating system, hypervisor, etc. may be used to manage the execution of application workloads and functions within the various virtual functions, virtual machines, containers, etc. The management software 1940 may also be used to identify the appropriate hardware to be accessed and used in the implementation of the application 1920. In some implementations, hardware devices in the set of hardware devices may be selected and used in the execution of the various applications that are to be instantiated and run within the system.

The various components (e.g., 1905, 1920, 1925, 1930, 1935, 1940, 1950, etc.) of the system may have associations or be provided by different providers, owners, and stakeholders with different usage models and incentives. For instance, orchestrator systems (e.g., 1905) may include user-specific applications launched on an associated OS/hypervisor, for instance, to perform VM instantiation/migration, application deployments, and container instantiation/migration. Deployments of applications 1920 may be paid for by user-customers on external service provider (ESP) infrastructure, while the management OS/hypervisor (e.g., 1940) may be typically owned by the ESPs and purchased from OS/HV developers. Traditionally, platform hardware (e.g., 1950) is owned by the ESP and hardware costs is paid in full by the component infrastructure providers to the SoC and platform managers, among other example stakeholders. Accordingly, in traditional distributed computing systems, service providers own the hardware platform, and pays for the full cost of ownership. Revenues of these service providers depend on users' utilization of hardware resources, however, service providers generally do not want to invest in a hardware features that do not have established and immediate revenue and profit generation potential. As such, hardware manufacturers may be disincentivized to bring new innovations to market without known demand from ESP platforms as they are unwilling to pay for features that they do not expect to use at time of procurement. Further, there may be a disconnect from the hardware and platform manufacturers and providers and the end users, without a viable service-based offering (e.g., HaaS) directly to users, among other example issues. In some implementations, one or more M-CDS devices (e.g., 705) may interface with devices incorporating the platform hardware elements (e.g., 1905) to assist in facilitating the sharing of corresponding hardware resources and supporting the commercialization of such sharing through hardware- or function-as-a-service offerings, among other example implementations.

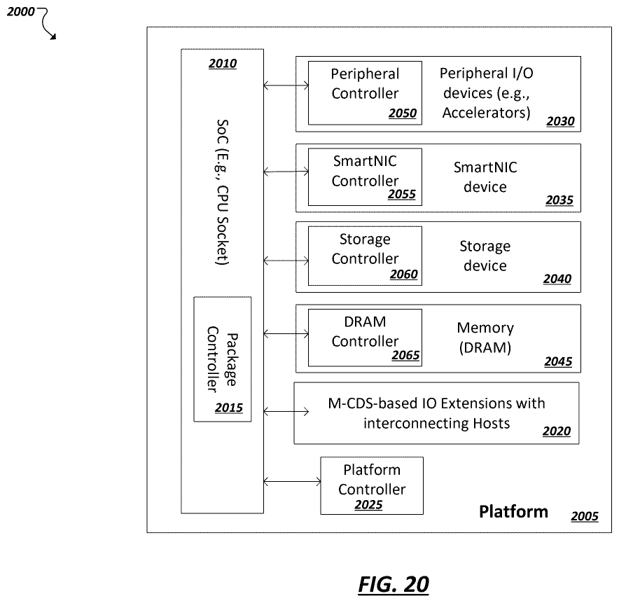

Turning to FIG. 20, a simplified block diagram 2000 is presented to illustrate an example computing platform (e.g., implemented on a single board, a package, etc.). In this example, the platform 2005 may include various hardware elements, including an interface to couple to (or use an internal) M-CDS device, through which I/O extensions (e.g., 2020) may be utilized to coordinate the sharing and configuration of the various hardware elements (e.g., 2010, 2030, 2035, 2040, 2045, etc.) with applications hosted by host systems external to the platform 2005. The platform 2005, in some implementations, may host multiple hardware resources, which be made available for sharing with external applications through one or more M-CDS devices. In this example, the hardware elements may include compute devices 2010 (e.g., SoC processor device, CPU, GPU, ASIC, etc.), peripheral I/O devices 2030 (e.g., hardware accelerator blocks, etc.), a SmartNIC or other networking hardware (e.g., 2035), storage elements (e.g., 2040), memory elements 2045 (e.g., DRAM components), among other examples.

The respective hardware elements (e.g., 2010, 2030, 2035, 2040, 2045, etc.) of an example platform 2005 may have respective controller blocks (e.g., 2015, 2050, 2055, 2060, 2065, etc.) to facilitate access to and use of the corresponding hardware elements, as well as perform configurations of the corresponding hardware elements, among other example features. The platform 2005 may also include a controller 2025, to allow control plane access to the platform 2005 and its respective hardware elements (and controller blocks). The M-CDS I/O extensions 2020, may enable the hardware element controllers (e.g., 2015, 2050, 2055, 2060, 2065, etc.) to interface with an M-CDS device (or network of interconnected M-CDS devices) to facilitate targeted and isolated communication over an M-CDS memory-based communication channel with one or more applications (e.g., hosted on one or more external host systems) and the hardware elements (e.g., 2010, 2030, 2035, 2040, 2045, etc.) and their respective hardware resources, allowing the applications to access and utilize these resources, as if they were local to the application's host, among other example features.

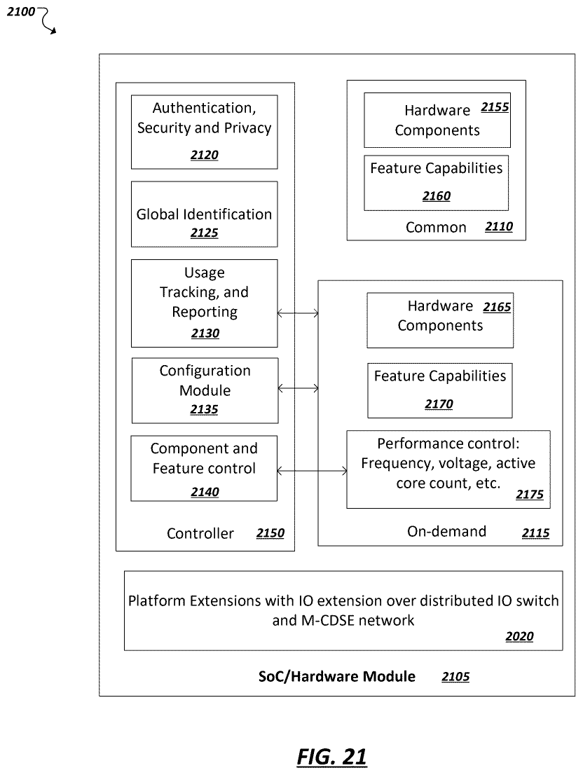

Turning to FIG. 21, a simplified block diagram 2100 is shown illustrating an example of a generic hardware element architecture (e.g., which could be employed in anyone of the example hardware components (e.g., 2010, 2030, 2035, 2040, 2045, etc.) in the example of FIG. 20). An example hardware element 2105 is shown, which includes a corresponding controller (e.g., 2150), which is configured to interface with one or more M-CDS devices to assist in implementing hardware resource sharing at the corresponding hardware element 2105. The controller 2105, or its equivalent, may be utilized, for instance, to implement any one of the controllers (e.g., 2015, 2025, 2050, 2055, 2060, 2065, etc.) of the example of FIG. 20. A controller 2150 may be used to facilitate the passage of data and control plane messages between the hardware element 2105 and an M-CDS device as well as management by an orchestrator or other management software in connection with the creation and use of a shared memory buffer used to facilitate access to a corresponding hardware element 2105 by an externally hosted application. The controller 2150 may also possess logic to appropriately configure the hardware element 2105 for its use by the externally hosted application.

In one example, the controller 2150 may include logic modules including an authentication, security, and privacy module 2120 to implement hardware configurations (e.g., specified or requested by an application in connection with the application's use of the hardware component 2105) relating to authentication, security, and data privacy. A global identification 2125 module may be utilized to coordinate system-wide or global identification of the hardware, a usage tracking module 2130 can be used to support and corroborate usage tracking performed by the M-CDS (e.g., in connection with a billing arrangement or other revenue generation associated with allowing shared usage of the hardware component), a configuration module 2135 to manage configuration of the hardware component 2105, and a feature control module 2140 to control which features of the hardware component 2105 are activated or otherwise made available in connection with a shared usage session by an application, among other examples. Some of the hardware resources (e.g., 2110) of the hardware elements 2105 may include hardware blocks (e.g., 2155) and associated capabilities and functionality (e.g., 2110) of the hardware components 2105 may be considered “common” in that there are always “on” or available and have standardized or static configurations. Other hardware resources (e.g., 2115) of the hardware elements 2105 may include hardware blocks (e.g., 2165) and associated capabilities and functionality (e.g., 2170), which may be configurable or activated “on demand” in association with the specific requests of an application that calls upon and uses the hardware element. The I/O extensions 2020 present on the hardware elements 2105 may implement at least a portion of the interface between the hardware element 2105 and one or more M-CDS devices for use in the exchange of data between the hardware elements 2105 (and its component hardware blocks (e.g., 2155, 2165)) in connection with access and use of the hardware component blocks by an external application.

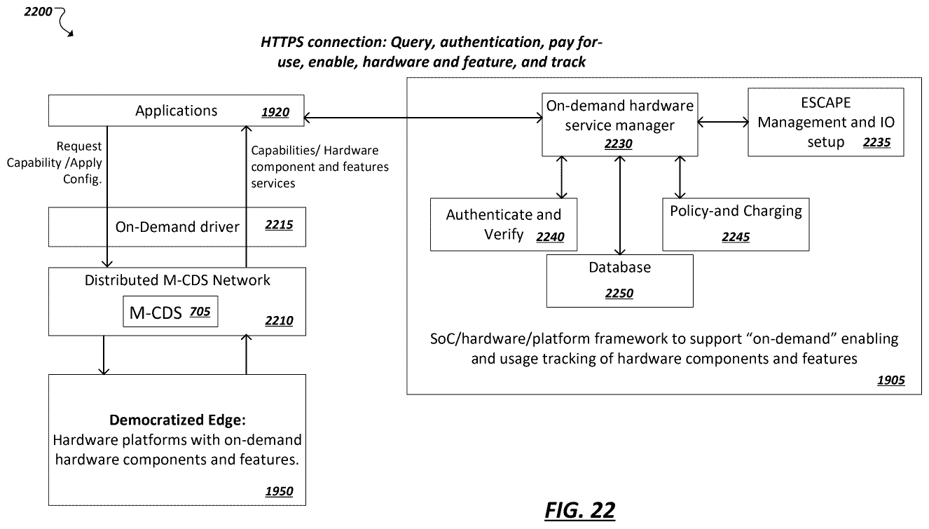

Turning to FIG. 22, a simplified block diagram 2200 is shown of example software-level components used in an on-demand enabling and use of example remote hardware resources using one or more M-CDS devices. Through I/O extensions (e.g., provided in the shared hardware elements and the host executing the application that is to access the hardware elements), an M-CDS device and an associated memory-based communication channels used to facilitate data exchange between the host and the shared hardware element may allow these remote hardware resources (e.g., storage, network adapter, accelerator circuitry, etc.) provided by the shared hardware element to appear local to the requesting host's software. An application 1920 may communicate with the M-CDS device (e.g., 705 incorporated in a distributed network of M-CDS devices, switches, and other elements interconnecting the M-CDS devices with various hardware elements 1950 (e.g., within a distributed edge computing environment)) through an on-demand driver 2215. Applications 1920 may also interface with orchestrator or other management software (e.g., 1905) to coordinate their hardware needs and arrange access (over M-CDS network 2210) with particular hardware elements (e.g., 1950) in the distributed system. An on-demand hardware service manager 2230 may be included to identify (e.g., from database 2250) the various hardware capabilities that are available through various hardware elements (e.g., 1950) present in the system and which are offered up for access within the system. The capability records in database 2250 may also identify the features of the hardware resources that may be configurable and what manner these hardware resources can be configured. Based on this information, hardware needs of a given application (e.g., 1920) may be identified (e.g., that are not readily available on its local host platform) and the hardware service manager 2230 may matchmake hardware resources of external hardware elements 1950 with the needs of the application 1920. As an illustrative example, a host of an application may identify that the application will demand performance of disk I/O that exceeds the host's local storage capacity. As such, through M-CDS 705, the management software 1905 may work to identify another host with excess storage and assist in configuring one or more M-CDS devices 705 to allow I/O requests from the application from the host to the other host (e.g., over a high-speed fabric). Similarly, networking IO can be handled across hosts to aggregate bandwidth or offload tasks that require more network resources than a single host can provide, among a myriad of other example use cases.

In some implementations, some of the hardware resources 1950 may have particular policies and pricing rules associated with their use. For instance, access to and use of a given hardware resource may be associated with a pay-as-you-go or subscription based pricing model and the respective pricing models attached to the respective hardware components may be based on the type of hardware component or function, the demand for the hardware component, the nature or identity of the consumer (or application provider), the nature of the hardware owner or provider, among other example factors. Other policies may be set to govern access and use of the hardware components, such as authentication policies, permission policies, use caps, and so on. For instance, management software 1905 may include an authentication and verification module 2240 used to perform authentication and user verification tasks associated with authenticating either or both the application (or application host) or the hardware component provider to each other. A policy and charging module 2245 may identify and consider the pricing policies and models associated with the various hardware capabilities and components listed in the database 2250 and the hardware service manager may utilize the combined information from the database, pricing models, and usage policies to identify a suitable set of one or more remote hardware components (e.g., in 1950) to establish a connection with over one or more M-CDS devices (e.g., 705) to enable a given application 1920 to access and use the capabilities of the set of hardware components. An M-CDS and I/O setup manager 2235 may be used to assist in configuring the M-CDS devices (e.g., 705) to be used in this connection to accurately establish the requisite M-CDS buffers (and policies to be enforced at the buffer) to create a memory-based communication channel between the application 1920 and the set of one or more hardware components to enforce continued isolation of the respective domains, enforce targeted and limited access between the application and hardware components, enforce data requirements and transforms in the data exchange, among other example policies.

An example capability structure is shown below that may represent a response or other information provided from a service manager to an application or its host OS/HV to consider in determining what capabilities are available on-demand from other hosts or hardware elements in the system, which may be leveraged (e.g., via one or more M-CDS connections) during execution of the application:

```
Capability Response: // (Sent from Service Manager to Applications)
      {
            SoC_CPU: {
                  Vendor Name; Vendor ID;
                  Global ID;
                  On-demand features_list: [1, 2, 3, 4 ...];
                  Contact_address: https:\\addressA; }
            Pheripheral_HW: {
                  Vendor Name; Vendor ID;
                  Global ID;
                  On-demand features_list: [1, 2, 3, 4 ...];
                  Contact_address: https:\\addressB; )
            Platform_HW: {
                  Vendor Name; Vendor ID;
                  Global ID;
                  On-demand features_list: [1, 2, 3, 4 ...];
                  Contact_address: https:\\addressC; }
            SmartNIC:{
                  Vendor Name; Vendor ID;
                  Global ID;
                  On-demand features_list: [1, 2, 3, 4 ...];
                  Contact_address: https:\\addressD; }
                  Others: (...);
}
```

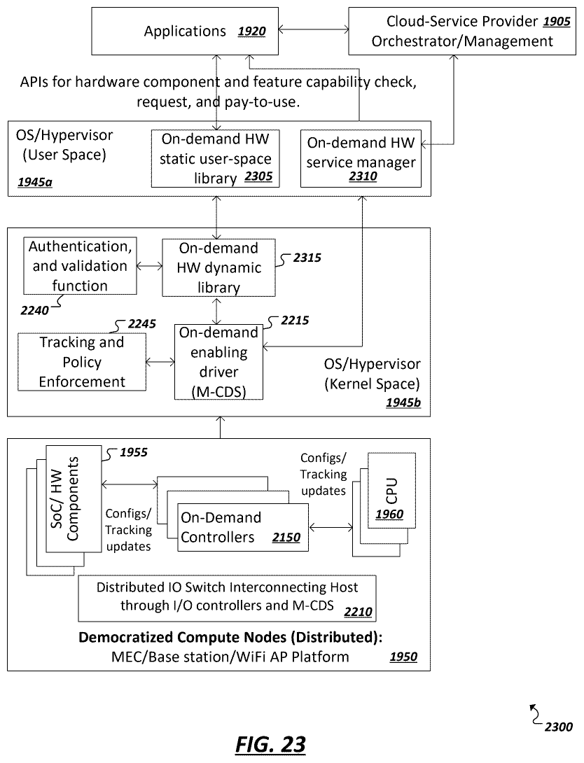

Turning to FIG. 23, a simplified block diagram 2300 is shown illustrating an example software implementation including software components in user space and kernel space used to facilitate on-demand enabling of hardware capabilities hosted by external compute nodes 1950 (e.g., hardware components 1955, other CPUs and other processors 1960, etc.) in a system. On-demand controller logic may be provided in the system to coordinate with controllers (e.g., 2150) of these hardware components and enable a fabric 2210 of one or more M-CDS devices to play a central role in dynamically managing and aggregating resources (e.g., memory, storage, and compute power) across multiple hosts. The primary function of an on-demand controller is to oversee resource allocation and deallocation based on the real-time requirements of workloads, enabling scalable and efficient resource usage. The on-demand controller may continuously monitor, allocate, and deallocate resources provided by the hardware elements 1905 to dynamically meet the needs of workloads of the application 1920, for instance, by leveraging memory pooling, storage aggregation, and high-performance I/O extensions, among other example capabilities to provide scalable, efficient, and fault-tolerant resources on-demand to applications within the system.

In some implementations, controller logic may be provided within O/S or hypervisor user space 1945a and kernel space 1945b. For instance, in user space 1945, an on-demand hardware static user space library 2305 may be provided and an on-demand service manager 2310 to interface with an orchestrator 1905 to coordinate demand and utilization on the application's host and/or the distributed hardware components by the application. Kernel space 1945b, in one example, may include authentication and validation logic 2240, tracking and policy enforcement logic 2245, and the M-CDS driver 2215. In some implementations, an on-demand hardware dynamic library 2315 may be provided. Hardware libraries (e.g., 2305, 2315) may be utilized to convert instructions compiled according to the application's (e.g., 1920) host system (e.g., with its respective instruction set architecture and executables) to those of the host system or hardware device hosting one or more remote hardware components to be accessed by the application via an M-CDS network.

As an illustrative example, a remote accelerator device (e.g., hosted on a device or platform separate or distinct from the platform hosting a given application) may be identified as possessing hardware resources and capabilities that may be advantageously leveraged by the given application as opposed to a general purpose processor on its host. The application may be compiled to include instructions or executables according to its host architecture that corresponding to a given task or workload, but these instructions and executables may be incompatible with the accelerator device the application seeks to leverage. A memory-based communication channel may be created through a buffer of an M-CDS device and serve to transfer executable code to the accelerator device from the application (and its host). Hardware libraries may be leveraged to convert the code into the substantially equivalent executables compatible with the accelerator device and the application may write these converted executables into the M-CDS device buffer to be read by the remote accelerator device. The accelerator device may execute this code (e.g., along with other data delivered through the M-CDS buffer(s), such as payload data to be executed in the workload) and generate corresponding result data, which the accelerator device may write to a corresponding M-CDS buffer to be read and consumed by the application (in subsequent workloads of the application). Prior to this transaction and the interactions between the application and the accelerator device, an orchestrator or other management software may coordinate with the host of the accelerator device to configure the accelerator device, if possible or suitable to the application's request, for use by the application. M-CDS management logic may also be invoked to coordinate the definition and instantiation of the buffers and buffer policies (e.g., buffer scheme definitions) to implement the requisite memory-based communication channels to effectively and securely implement the data exchanges between the application, its host, and the remote hardware device, among other example implementations and features.

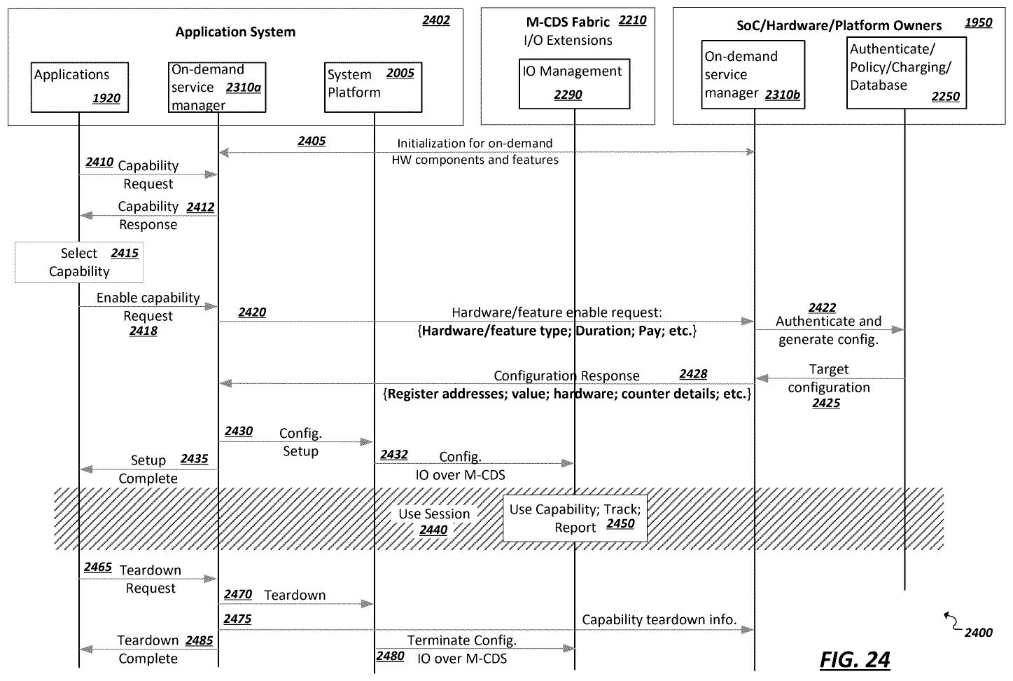

Turning to FIG. 24, a simplified flow diagram 2400 is shown illustrating a example techniques for enabling application running on various platforms (e.g., CSP or ESP infrastructure) to be able to access and use hardware features provided through remote or external hardware elements in a manner specific to the application in a pay-as-you-go or subscription-based service model. In this example, an application 1920 hosted on an application system 2402, possessing local system platform hardware 2005 may be provided and may be initialized 2405 (e.g., by an orchestrator system), together with an M-CDS fabric 2210 and one or more other hardware platforms 1950 (external to the application system 2402 and system platform 2005) to support on-demand access and sharing of hardware components and features. During the initialization 2405, an on-demand service manager 2310a on the application system 2402 (e.g., implemented in the corresponding ESP OS/HV infrastructure) queries the hardware infrastructure 1905 (e.g., through a corresponding service manager 2310b), and communicates with the hardware system 1905 to determine the supported capabilities for on-demand hardware services. The on-demand-service-managers (e.g., 2310a-b) may serve as anchors of the systems' coordination of initialization, setup, tracking, and tear down of the application-requested use of on-demand hardware components and features. As noted above, one or more databases (e.g., may be implemented (e.g., at an orchestrator, at hardware server infrastructure 1950, etc.) and may be used to generate configurations, can authenticate request, enforce policy, and track usage and coordinate payments for enabling the hardware components, and features on the remote platforms. In some implementations, the communication between compute platforms, the hardware servers, and orchestration logic may be established by traditional networking connections (e.g., HTTPS) to be able to interact, and coordinate the on-demand resource allocation during run-time.

Applications that are initialized to be aware of such on-demand features may use libraries (e.g., the user-space library) to interact with service manager of compute to request the available enhancement hardware components and features. Upon request, the service manager may respond 2412 with a capability list illustrating the remote hardware resources that may be capable of being accessed by the application 1920. The application 1920 can then select 2415 the desired feature (e.g., hardware acceleration component, networking component, storage component, etc.) that would facilitate and improve the application performance and a corresponding capability request 2418 may be issued by the application 2402 to the service manager (e.g., 2310a). The application's service manager 2310a may send a request 2420 to a service manager 2310b of the selected hardware component, including requested hardware configuration, desired feature activation, payment or billing information (e.g., rate selection), among other example information. The hardware system 1950 (e.g., or a specific server of the owner or provider of the hardware component) may authenticate the request (at 2422) and upon successful authentication may work to configure the target hardware component according to the request 2420. The hardware component providers may respond 2425 with details of the hardware, configuration, and features details along with other information, such as software APIs, device information, and register/counter information for setup and tracking, among other information, to the service manager 2310b for setting up on-demand resources of the identified or request hardware device. This information can be sent as a response 2428 from the service manager 1305b of the hardware system to the service manager 1305a of the application system 2402.

Continuing with the example of FIG. 24, with the hardware resources and application platform configured to participate in an on-demand hardware services session, an M-CDS device in M-CDS fabric 2210 may also be configured to create the buffers for the corresponding memory-based communication channels between the application system 2402 and the hardware component systems (e.g., 1905) to facilitate data exchange in accordance with the configuration negotiated between the service managers (e.g., 1305a, 1305b) of the hosts of the application (e.g., 2402) and hardware elements and their components. The service managers may further coordinate (at 2430) with their local platforms (e.g., 2005) to establish an interface or connection with the M-CDS device such that reads, writes, and accesses to the M-CDS shared memory can be performed and I/O can be configured (at 2432) between the M-CDS fabric 2210 (e.g., using I/O manager) and the application's platform 2005. A similar configuration of the connection between the hardware device and the M-CDS device can be established (although not explicitly illustrated in the example of FIG. 24 for brevity).

With the application, hardware elements, and M-CDS device buffers properly configured, the application 1920 may be notified (at 2435) that the setup is complete and an on-demand hardware use session 2440 can commence with workloads being passed (e.g., through the passing of instructions or data to be operated upon, stored, or handled) from the application to the hardware through a corresponding buffer of the M-CDS device. Likewise, data (e.g., result data and other information generated at the hardware element) may be passed from the hardware element to the application through a corresponding buffer of the M-CDS device. As these data exchanges take place, the M-CDS device may monitor the respective accesses of the buffers in the M-CDS shared memory that have been created to facilitate an application's use of one or more hardware elements. The M-CDS device may track these accesses (e.g., in accordance with usage or pricing policies defined for the on-demand session) to calculate and record metrics of an application's use of the hardware elements. Such accesses and metrics may include a number of requests by the application, an amount of data or type of data exchanged, an amount of data returned by the hardware, an amount of time the buffers remain open to facilitate the data exchanges, among other example attributes of an application's interactions, through the M-CDS device, with the hardware element. The metric tracked (at 2450) by the M-CDS device may constitute neutral, third-party monitoring and usage tracking, which may serve as the ground truth for determining service fees to be charged (e.g., by the hardware provider, owner, or manufacturer to the application provider or owner). Indeed, such usage information may be maintained in a register or other storage of the M-CDS device for access in determining and implementing billing for the corresponding on-demand pricing model.

Continuing with the example of FIG. 24, when an application is finished utilizing an external hardware resource, the application 1920 can issue a teardown request 2465 to the local service manager 2310a to disengage with the external hardware resource and initiate the teardown of the corresponding M-CDS I/O channels used to facilitate interactions with the hardware resource. In other instances, the hardware resource (or the host of the hardware resource) may initiate the end of the session 2440, for instance, based on a policy violation, usage limit, among other examples. In this example of FIG. 24, the service manager 2310a may respond to the tear down request 2465 by initiating the tear down 2470 of the connection to the M-CDS device by the system platform and sending a control plane message 2475 to a service manager 2310b associated with the hardware system with information corresponding to the intent to discontinue the use session 2440 and access to the hardware capabilities furnished by the hardware resource host. The M-CDS device may terminate (at 2480) the memory based communication channel used in the session 2440 and, in some cases, tear down the associated buffers in the M-CDS shared memory to make the memory available for other memory-based communication channel. With the M-CDS device and hardware system notified of the end of the use session 2440 and requested to tear down the associated I/O infrastructure, the service manager 2310a may confirm the tear down (at 2485) to the application 1920, which may continue, in some instances, to operate, albeit without the use of the released external hardware resources.

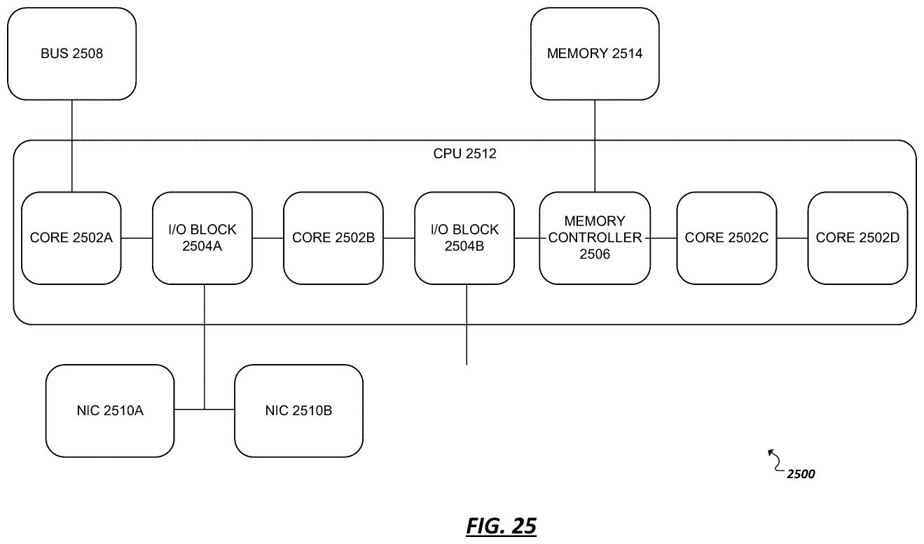

Note that the apparatus', methods', and systems described above may be implemented in any electronic device or system as aforementioned. As a specific illustration, FIG. 25 provides an exemplary implementation of a processing device such as one that may be included in a network processing device. It should be appreciated that other processor architectures may be provided to implement the functionality and processing of requests by an example network processing device, including the implementation of the example CDS device components and functionality discussed above.

Referring to FIG. 25, a block diagram 2500 is shown of an example data processor device (e.g., a central processing unit (CPU)) 2512 coupled to various other components of a platform in accordance with certain embodiments. Although CPU 2512 depicts a particular configuration, the cores and other components of CPU 2512 may be arranged in any suitable manner. CPU 2512 may comprise any processor or processing device, such as a microprocessor, an embedded processor, a digital signal processor (DSP), a network processor, an application processor, a co-processor, a system on a chip (SOC), or other device to execute code. CPU 2512, in the depicted embodiment, includes four processing elements (cores 2502 in the depicted embodiment), which may include asymmetric processing elements or symmetric processing elements. However, CPU 2512 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 2512, as illustrated in FIG. 25, includes four cores-cores 2502A, 2502B, 2502C, and 2502D, though a CPU may include any suitable number of cores. Here, cores 2502 may be considered symmetric cores. In another embodiment, cores may include one or more out-of-order processor cores or one or more in-order processor cores. However, cores 2502 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 2502 may include a decode module coupled to a fetch unit to decode fetched elements. Fetch logic, in one embodiment, includes individual sequencers associated with thread slots of cores 2502. Usually a core 2502 is associated with a first ISA, which defines/specifies instructions executable on core 2502. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, decoders may, in one embodiment, include logic designed or adapted to recognize specific instructions, such as transactional instructions. As a result of the recognition by the decoders, the architecture of core 2502 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 2502, in one embodiment, recognize the same ISA (or a subset thereof). Alternatively, in a heterogeneous core environment, a decoder of one or more cores (e.g., core 2502B) may recognize a second ISA (either a subset of the first ISA or a distinct ISA).

In various embodiments, cores 2502 may also include one or more arithmetic logic units (ALUs), floating point units (FPUs), caches, instruction pipelines, interrupt handling hardware, registers, or other suitable hardware to facilitate the operations of the cores 2502.

Bus 2508 may represent any suitable interconnect coupled to CPU 2512. In one example, bus 2508 may couple CPU 2512 to another CPU of platform logic (e.g., via UPI). I/O blocks 2504 represents interfacing logic to couple I/O devices 2510 and 2515 to cores of CPU 2512. In various embodiments, an I/O block 2504 may include an I/O controller that is integrated onto the same package as cores 2502 or may simply include interfacing logic to couple to an I/O controller that is located off-chip. As one example, I/O blocks 2504 may include PCIe interfacing logic. Similarly, memory controller 2506 represents interfacing logic to couple memory 2514 to cores of CPU 2512. In various embodiments, memory controller 2506 is integrated onto the same package as cores 2502. In alternative embodiments, a memory controller could be located off chip.

As various examples, in the embodiment depicted, core 2502A may have a relatively high bandwidth and lower latency to devices coupled to bus 2508 (e.g., other CPUs 2512) and to NICs 2510, but a relatively low bandwidth and higher latency to memory 2514 or core 2502D. Core 2502B may have relatively high bandwidths and low latency to both NICs 2510 and PCIe solid state drive (SSD) 2515 and moderate bandwidths and latencies to devices coupled to bus 2508 and core 2502D. Core 2502C would have relatively high bandwidths and low latencies to memory 2514 and core 2502D. Finally, core 2502D would have a relatively high bandwidth and low latency to core 2502C, but relatively low bandwidths and high latencies to NICs 2510, core 2502A, and devices coupled to bus 2508.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stages, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, such as reset, while an updated value potentially includes a low logical value, such as set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a processor; a memory, where the memory is to implement a shared memory region; and code executable by the processor to: determine a hardware resource of a first device to be accessed and used by a program executed on a second device; create a buffer in the shared memory region to implement a restricted memory-based communication channel to facilitate data exchange between the first device and the second device in association with use of the hardware resource by the program; enforce at least one policy at the buffer to restrict the data exchange on the memory-based communication channel between the first device and the second device; monitor the buffer to measure an amount of usage of the hardware resource by the program; and generate usage data to identify the amount of usage.

Example 2 includes the subject matter of example 1, where the amount of usage corresponds to one of a number of writes by the program to the at least one buffer or an amount of data exchanged over the at least one buffer from the program to the hardware resource.

Example 3 includes the subject matter of any one of examples 1-2, where the amount of usage is associated with a billing policy for use of the hardware resource.

Example 4 includes the subject matter of any one of examples 1-3, where the at least one policy restricts writes to the at least one buffer to the program and reads from the at least one buffer to an agent associated with the hardware resource.

Example 5 includes the subject matter of any one of examples 1-4, where the code is further executable to: identify that a second program executed on a third device is to access and use the hardware resource; and create a second buffer in the shared memory region to implement a second restricted memory-based communication channel to facilitate data exchange between the first device and the third device in association with use of the hardware resource by the second program.

Example 6 includes the subject matter of any one of examples 1-5, where the code is further executable to: determine a second hardware resource on a third device is to be accessed and used by the program; and create a second buffer in the shared memory region to implement a second restricted memory-based communication channel to facilitate data exchange between the second device and the third device in association with use of the second hardware resource by the program.

Example 7 includes the subject matter of any one of examples 1-6, where the hardware resource includes a hardware component of one of a hardware accelerator, an I/O device, a storage device, or a network controller device.

Example 8 includes the subject matter of any one of examples 1-7, where the code is further executable by the processor to: determine an end of the use of the hardware resource by the program; and tear down the at least one buffer to end the memory-based communication channel based on the end of the use of the hardware resource by the program.

Example 9 includes the subject matter of any one of examples 1-8, where enforcement of the at least one policy to isolate a domain of the first device from a domain of the second device.

Example 10 includes the subject matter of any one of examples 1-9, where the code is further executable by the processor to provide access to the usage data by at least one of the first device or the second device.

Example 11 includes the subject matter of any one of examples 1-10, where the buffer includes a first buffer and a second buffer, the at least one policy defines that the first device is to write to the first buffer and read from the first buffer and that the second device is to write to the second buffer and read from the second buffer.

Example 12 is a non-transitory machine-readable storage medium with instructions stored thereon, the instructions executable by a machine to cause the machine to: receive a request from an application to access a hardware capability, where the application is executed on a first computing platform, and the hardware capability is to be provided by computing hardware external to the first computing platform; identify that a hardware device includes the hardware capability; send a request to the hardware device, where the request identifies a configuration to be applied in the hardware device; send a request to a memory-based cross-domain-solution (M-CDS) device to initialize at least one buffer in shared memory of the M-CDS device, where the at least one buffer is to implement a memory-based communication channel between the first computing platform and the hardware device; and initiate a use session, where a workload of the application is performed on the hardware device in the use session, input data associated with the workload is to be exchanged from the application to the hardware device and output data associated with the workload is to be exchanged from the hardware device to the application through the at least one buffer.

Example 13 includes the subject matter of example 12, where the instructions are further executable to cause the machine to: identify a billing policy associated with use of the hardware device; and receive usage data for the use session as measured by the M-CDS device to determine pricing associated with the use session based on the billing policy.

Example 14 includes the subject matter of any one of examples 12-13, where the configuration is to activate a feature of the hardware device associated with the hardware capability, where the feature is disabled by default at the hardware device.

Example 15 includes the subject matter of any one of examples 12-14, where the instructions are further executable to cause the machine to: receive a request from the application to end the use session; send a notification to the hardware device that the use session is to end; and send a notification to the M-CDS device to cause the buffer to be torn down based on the end of the use session.

Example 16 includes the subject matter of any one of examples 12-15, where the M-CDS device includes the apparatus of any one of examples 1-11.

Example 17 is a system including: a first computing device including: a first processor; an application including code executable by the first processor to perform a set of tasks; and a memory-based cross-domain solution (M-CDS) device coupled to the first computing device, where the M-CDS device includes: a second processor; a shared memory; and code executable by the second processor to: identify a hardware resource of a hardware device to be accessed and used by the application; create a buffer in the shared memory region to implement a restricted memory-based communication channel to facilitate data exchange between the first computing device and the hardware device in association with use of the hardware resource by the application; enforce at least one policy at the buffer to restrict the data exchange on the memory-based communication channel between the first computing device and the hardware device; monitor the buffer to measure an amount of usage of the hardware resource by the application; and generate usage data to identify the amount of usage.

Example 18 includes the subject matter of example 17, where hardware device is remote from the first computing device, and the buffer causes the hardware device to appear local to the first computing device.

Example 19 includes the subject matter of any one of examples 17-18, further including a billing system to: determine a billing policy for the hardware device; and determine pricing for the usage of the hardware resource by the application based on the usage data and billing policy.

Example 20 includes the subject matter of any one of examples 17-19, where the hardware resource includes a hardware component in a plurality of hardware components of the hardware device.

Example 21 includes the subject matter of example 20, where the at least one policy is enforced to restrict writes to the buffer to only the application and restrict reads to the buffer to only an agent associated with the given hardware component.

Example 22 includes the subject matter of any one of examples 17-21, further including a service manager including code executable by a processor to: receive a request from the application to access a hardware capability; identify that the hardware device includes the hardware capability; send a request to the hardware device, where the request identifies a configuration to be applied to the hardware device; send a request to the M-CDS device to initialize the at least one buffer; and initiate a use session, where a workload of the application is performed on the hardware device in the use session, input data associated with the workload is to be exchanged from the application to the hardware device and output data associated with the workload is to be exchanged from the hardware device to the application through the at least one buffer.

Example 23 includes the subject matter of any one of examples 17-22, where the M-CDS device includes the apparatus of any one of examples 1-11.

Example 24 is a method including: receiving a request from an application to access a hardware capability, where the application is executed on a first computing platform, and the hardware capability is to be provided by computing hardware external to the first computing platform; identifying that a hardware device includes the hardware capability; sending a request to the hardware device, where the request identifies a configuration to be applied in the hardware device; sending a request to a memory-based cross-domain-solution (M-CDS) device to initialize at least one buffer in shared memory of the M-CDS device, where the at least one buffer is to implement a memory-based communication channel between the first computing platform and the hardware device; and initiating a use session, where a workload of the application is performed on the hardware device in the use session, input data associated with the workload is to be exchanged from the application to the hardware device and output data associated with the workload is to be exchanged from the hardware device to the application through the at least one buffer.

Example 25 includes the subject matter of example 24, further including: identifying a billing policy associated with use of the hardware device; and receiving usage data for the use session as measured by the M-CDS device to determine pricing associated with the use session based on the billing policy.

Example 26 includes the subject matter of any one of examples 24-25, where the configuration is to activate a feature of the hardware device associated with the hardware capability, where the feature is disabled by default at the hardware device.

Example 27 includes the subject matter of any one of examples 24-26, further including: receiving a request from the application to end the use session; sending a notification to the hardware device that the use session is to end; and sending a notification to the M-CDS device to cause the buffer to be torn down based on the end of the use session.

Example 28 includes the subject matter of any one of examples 24-27, where the M-CDS device includes the apparatus of any one of examples 1-11.

Example 29 is a system including means to perform the method of any one of examples 24-29.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a processor;
a memory, wherein the memory is to implement a shared memory region; and
code executable by the processor to:
determine a hardware resource of a first device to be accessed and used by a program executed on a second device;
create a buffer in the shared memory region to implement a restricted memory-based communication channel to facilitate data exchange between the first device and the second device in association with use of the hardware resource by the program;
enforce at least one policy at the buffer to restrict the data exchange on the memory-based communication channel between the first device and the second device;
monitor the buffer to measure an amount of usage of the hardware resource by the program; and
generate usage data to identify the amount of usage.

2. The apparatus of claim 1, wherein the amount of usage corresponds to one of a number of writes by the program to the at least one buffer or an amount of data exchanged over the at least one buffer from the program to the hardware resource.

3. The apparatus of claim 1, wherein the amount of usage is associated with a billing policy for use of the hardware resource.

4. The apparatus of claim 1, wherein the at least one policy restricts writes to the at least one buffer to the program and reads from the at least one buffer to an agent associated with the hardware resource.

5. The apparatus of claim 1, wherein the code is further executable to:
identify that a second program executed on a third device is to access and use the hardware resource; and
create a second buffer in the shared memory region to implement a second restricted memory-based communication channel to facilitate data exchange between the first device and the third device in association with use of the hardware resource by the second program.

6. The apparatus of claim 1, wherein the code is further executable to:
determine a second hardware resource on a third device is to be accessed and used by the program; and
create a second buffer in the shared memory region to implement a second restricted memory-based communication channel to facilitate data exchange between the second device and the third device in association with use of the second hardware resource by the program.

7. The apparatus of claim 1, wherein the hardware resource comprises a hardware component of one of a hardware accelerator, an I/O device, a storage device, or a network controller device.

8. The apparatus of claim 1, wherein the code is further executable by the processor to:
determine an end of the use of the hardware resource by the program; and
tear down the at least one buffer to end the memory-based communication channel based on the end of the use of the hardware resource by the program.

9. The apparatus of claim 1, wherein enforcement of the at least one policy to isolate a domain of the first device from a domain of the second device.

10. The apparatus of claim 1, wherein the code is further executable by the processor to provide access to the usage data by at least one of the first device or the second device.

11. The apparatus of claim 1, wherein the buffer comprises a first buffer and a second buffer, the at least one policy defines that the first device is to write to the first buffer and read from the first buffer and that the second device is to write to the second buffer and read from the second buffer.

12. At least one non-transitory machine-readable storage medium with instructions stored thereon, the instructions executable by a machine to cause the machine to:
receive a request from an application to access a hardware capability, wherein the application is executed on a first computing platform, and the hardware capability is to be provided by computing hardware external to the first computing platform;
identify that a hardware device comprises the hardware capability;
send a request to the hardware device, wherein the request identifies a configuration to be applied in the hardware device;
send a request to a memory-based cross-domain-solution (M-CDS) device to initialize at least one buffer in shared memory of the M-CDS device, wherein the at least one buffer is to implement a memory-based communication channel between the first computing platform and the hardware device; and
initiate a use session, wherein a workload of the application is performed on the hardware device in the use session, input data associated with the workload is to be exchanged from the application to the hardware device and output data associated with the workload is to be exchanged from the hardware device to the application through the at least one buffer.

13. The storage medium of claim 12, wherein the instructions are further executable to cause the machine to:
identify a billing policy associated with use of the hardware device; and
receive usage data for the use session as measured by the M-CDS device to determine pricing associated with the use session based on the billing policy.

14. The storage medium of claim 12, wherein the configuration is to activate a feature of the hardware device associated with the hardware capability, wherein the feature is disabled by default at the hardware device.

15. The storage medium of claim 12, wherein the instructions are further executable to cause the machine to:
receive a request from the application to end the use session;
send a notification to the hardware device that the use session is to end; and
send a notification to the M-CDS device to cause the buffer to be torn down based on the end of the use session.

16. A system comprising:
a first computing device comprising:
a first processor;
an application comprising code executable by the first processor to perform a set of tasks; and
a memory-based cross-domain solution (M-CDS) device coupled to the first computing device, wherein the M-CDS device comprises:
a second processor;
a shared memory; and
code executable by the second processor to:
identify a hardware resource of a hardware device to be accessed and used by the application;
create a buffer in the shared memory to implement a restricted memory-based communication channel to facilitate data exchange between the first computing device and the hardware device in association with use of the hardware resource by the application;
enforce at least one policy at the buffer to restrict the data exchange on the memory-based communication channel between the first computing device and the hardware device;
monitor the buffer to measure an amount of usage of the hardware resource by the application; and
generate usage data to identify the amount of usage.

17. The system of claim 16, wherein hardware device is remote from the first computing device, and the buffer causes the hardware device to appear local to the first computing device.

18. The system of claim 16, further comprising a billing system to:
determine a billing policy for the hardware device; and
determine pricing for the usage of the hardware resource by the application based on the usage data and billing policy.

19. The system of claim 16, wherein the hardware resource comprises a hardware component in a plurality of hardware components of the hardware device.

20. The system of claim 19, wherein the at least one policy is enforced to restrict writes to the buffer to only the application and restrict reads to the buffer to only an agent associated with the hardware component.
